(19) United States
(12) Patent Application Publication
(10) Pub. No.: US 2026/0289409 A1
(43) Pub. Date: Sep. 24, 2026

(54) SYSTEM

(71) Applicant: SoftBank Group Corp., Tokyo (JP)

(72) Inventor: Kazuya TAKAKI, Tokyo (JP)

(73) Assignee: SoftBank Group Corp., Tokyo (JP)

(21) Appl. No.: 19/568,784

(22) Filed: Mar. 17, 2026

(30) Foreign Application Priority Data
Mar. 19, 2025 (JP) 2025-045178

(51) Int. Cl. G06N 20/00; G06F 40/10

(52) U.S. Cl. CPC G06N 20/00; G06F 40/10

(57) ABSTRACT

A system includes a processor that is configured to receive market information and target user information, and perform emotion analysis to recognize a user emotion, generate a prompt for instructing a generative AI model to generate a design or text, the prompt being generated based on the received information and a result of the emotion analysis, and distribute personalized content to an end user by using the generated design or text via at least one of an electronic mail platform and a social network advertising platform.

### CROSS-REFERENCE TO RELATED APPLICATION

This application is based on and claims priority under 35 USC 119 from Japanese Patent Application No. 2025-045178 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional digital marketing systems, content delivered to end users via electronic mail or social network advertising platforms is often generated based only on static market information or simple user attributes such as age, gender, or purchase history. As a result, the content frequently fails to reflect a user's current emotional state, leading to low engagement, reduced effectiveness of campaigns, and limited personalization. Furthermore, although generative AI models are increasingly used for automatically creating designs and text, existing systems do not adequately integrate emotion analysis results, or features extracted from photographs and videos, into the prompts supplied to such generative AI models. Consequently, the generated content may not be contextually appropriate or emotionally resonant for the target user. In addition, many systems do not provide a unified mechanism for converting AI-generated designs and text into multiple output formats, such as online advertisements, flyers, and direct mail, and for consistently delivering such personalized content to end users across different channels. Therefore, there is a need for a system capable of recognizing user emotions, incorporating emotion analysis results and image-derived features into prompts for generative AI models, and efficiently distributing personalized content in various formats via electronic mail and social network advertising platforms.

### SUMMARY

In order to solve the above-described problems, according to one aspect of the present invention, there is provided a system comprising a processor, wherein the processor is configured to receive market information and target user information, and perform emotion analysis to recognize a user emotion; to generate a prompt for instructing a generative AI model to generate a design or text, the prompt being generated based on the received market information, the received target user information, and a result of the emotion analysis; and to distribute personalized content to an end user by using the generated design or text via at least one of an electronic mail platform and a social network advertising platform. The processor may further be configured to cooperate with an image analysis system that analyzes at least one of photograph data and video data to obtain an image feature, and to generate the prompt for instructing the generative AI model to generate the design or the text based on the image feature in addition to the received information and the emotion analysis result. Moreover, the processor may be configured to convert the generated design or text into at least one of an advertisement, a flyer, and a direct mail, and to approach the end user by using the converted content. By these means, the system can generate emotionally adaptive, context-aware prompts for the generative AI model, produce highly personalized designs and text, and deliver such content in multiple formats and channels, thereby improving user engagement and marketing effectiveness.

The term “market information” refers to information indicating characteristics of a market segment, including but not limited to demographic distributions, typical age ranges, typical hobbies, consumer behavior patterns, and descriptive data that identify a target group of users.

The term “target user information” refers to information related to an individual user or a group of users, including but not limited to a user's age, gender, hobbies, purchase history, preferences, interests, needs, and identifiers used to distinguish the user from other users.

The term “emotion analysis” refers to a process of analyzing data associated with a user, such as text, voice, images, or behavioral logs, in order to recognize or estimate an emotional state of the user, for example happiness, sadness, excitement, or frustration.

The term “user emotion” refers to an emotional state or affective condition of a user at a given time or within a given context, as recognized or estimated by the emotion analysis.

The term “generative AI model” refers to an artificial intelligence model configured to generate new content, such as designs, images, layouts, or text, in response to an input, including but not limited to neural network-based generative models and large language models.

The term “design” refers to digital representation data defining a visual layout, including at least one of a color scheme, a font, a composition, an image arrangement, or a graphical element configuration suitable for presentation to an end user.

The term “text” refers to a sequence of characters or words that forms a human-readable message, sentence, paragraph, or document to be presented to an end user.

The term “prompt” refers to a data structure or input instruction supplied to the generative AI model, the data structure or input instruction including at least one of a natural language description, a parameter setting, or a control token, and specifying conditions for generating the design or the text.

The term “personalized content” refers to content whose design and/or text has been generated or adapted based on at least one of the market information, the target user information, the user emotion, and an image feature so that the content is tailored to a particular end user or user segment.

The term “electronic mail platform” refers to a system or service that enables composition, transmission, and reception of electronic mail messages and that is capable of delivering the personalized content to an end user via email.

The term “social network advertising platform” refers to an online service associated with a social network that provides mechanisms for creating, managing, and distributing advertisements to users, and that can deliver the personalized content as an advertisement to an end user.

The term “image analysis system” refers to a system configured to process and analyze image data, including at least one of photograph data and video data, to extract features such as objects, scenes, colors, facial expressions, or other visual attributes.

The term “image feature” refers to information extracted from image data by the image analysis system, including but not limited to detected objects, recognized scenes, color distributions, shapes, motion patterns, or inferred emotions, which can be used as a condition for generating the design or the text.

The term “advertisement” refers to content intended for promoting a product, service, or brand, where the content includes at least one of the generated design and the generated text and is presented through an online or offline medium.

The term “flyer” refers to a layout for printed or digital distribution that typically contains promotional information in a single or multiple page format, and that is created by placing the generated design and/or the generated text into a predetermined template.

The term “direct mail” refers to a targeted communication sent directly to an end user via a delivery channel such as postal mail or electronic mail, the communication including at least one of the generated design and the generated text.

The term “end user” refers to a recipient of the personalized content who is a target of marketing or communication activities and whose attributes and emotional state are considered in generating the content.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

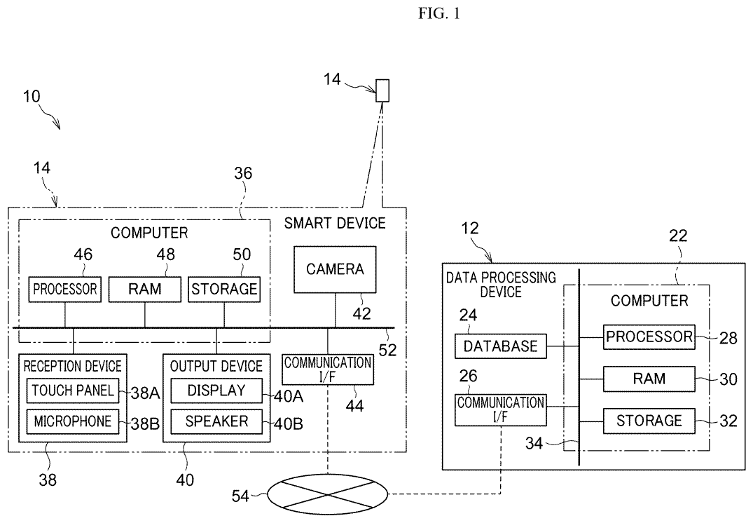

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

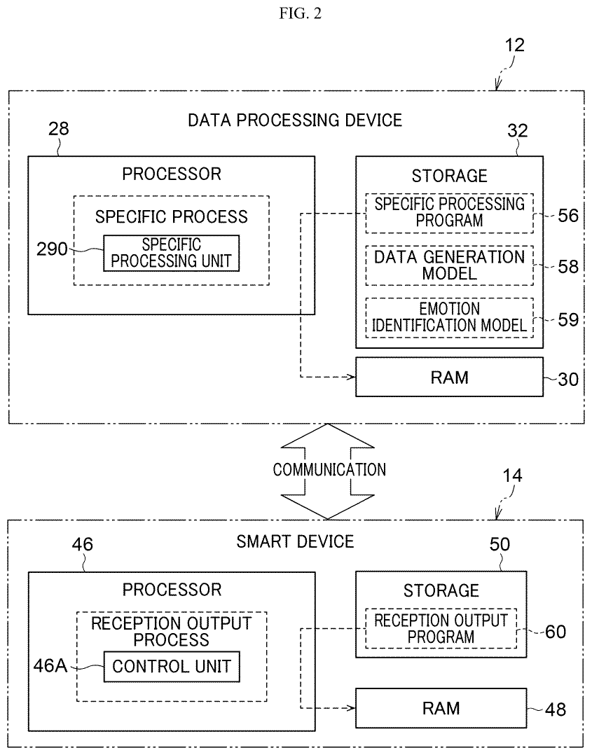

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content personalization systems typically rely on static rule engines or manually authored templates that are applied to user segments defined only by simple demographic attributes. In such systems, a processor generally selects preexisting text or visual elements based on basic filters and then distributes the selected content to end users through electronic communication services or social network advertising services. This architecture suffers from several technical limitations in terms of data handling, model interaction, and delivery optimization.

First, conventional systems do not systematically transform heterogeneous market information and attribute information of a target population into structured, machine-optimized feature data that can be used as a coherent input for a generative AI model. As a result, the processor often operates on loosely structured records or key-value stores, which leads to inefficient memory access patterns, redundant computation, and difficulty in unifying internal information and external information obtained from external information providing devices.

Second, known systems typically pass a user's high-level instruction sentence directly to a generative AI model without expanding the instruction into a detailed, model-oriented prompt sentence that encodes statistical information, preference information, and output format information of the target population. This direct use of high-level instructions limits the model's ability to generate content that is tightly aligned with the actual distribution of user attributes and behaviors and forces the processor to perform repeated trial-and-error interactions with the model. Consequently, system throughput decreases and latency increases, and computing resources such as central processing units and graphics processing units are used inefficiently.

Third, many existing personalization engines do not provide an integrated mechanism to connect the preprocessing of attribute information, the generation of content by a generative AI model, and the per-recipient assignment of generated content into a single, consistent processing pipeline. Instead, preprocessing, generation, and assignment are often implemented as separate modules that exchange intermediate files or loosely coupled messages. This fragmented architecture introduces additional data conversion overhead, inconsistent representations of user segments, and increased risk of errors in correlating generated content with the correct recipients.

Fourth, conventional systems generally lack a processor-level mechanism for automatically generating individualized delivery messages by combining selected generated content with per-recipient attribute information in a structured way. Without a unified assignment process that can apply assignment rules or statistical and machine learning-based evaluation processes, the processor cannot effectively determine which of multiple generated variants should be assigned to each recipient. This reduces the ability of the system to improve delivery performance indicators, such as open rates and click-through rates, based on observed results.

Accordingly, there is a need for an improved computer-implemented system that: (i) acquires related information from multiple sources and converts it into generation feature data through structured preprocessing; (ii) automatically generates an expanded generative AI model prompt sentence that expresses both a user's high-level intent and detailed segment-level statistics; (iii) invokes a generative AI model to produce text and visual content in a form that is immediately usable by downstream processing; and (iv) assigns and delivers the generated content to individual recipients based on their attribute information through a unified, processor-controlled pipeline. Such a system should improve the efficiency and reliability of content generation and delivery operations, reduce redundant data transformations, and enhance the technical performance of computers executing these processes.

The specific processing by the specific processing unit 290 of the data processing device 12 in Example 1 is realized by the following means.

The present invention provides a server comprising a processor configured to receive market information and attribute information of a target population, to acquire related information from an information storage device and an external information providing device based on the market information and the attribute information, to perform preprocessing on the related information and the attribute information by using an information processing program, the preprocessing including normalization processing, encoding processing, feature extraction processing, missing value processing, scale transformation of numerical features, and numerical representation conversion of categorical features, to store the preprocessed information in a tabular data structure and generate generation feature data, to generate, based on the generation feature data and a high-level instruction sentence input by a user, a generative AI model prompt sentence by expanding the high-level instruction sentence to include statistical information of the target population, preference information, and output format information calculated from the tabular data structure, to execute a content generation program by using the generative AI model prompt sentence and the generation feature data as input to a generative AI model, thereby generating generated content including character information and visual information, to perform postprocessing on the generated content, the postprocessing including format conversion processing, component organization processing, and individual identification information assignment processing, and to generate delivery content resources and management information associated with the delivery content resources, to present the delivery content resources and the management information to a terminal device including a display device, to accept candidate selection operations by the user and identify selected delivery content resources, to assign, based on the selected delivery content resources and attribute information of individual recipients belonging to the target population, the delivery content resources to each recipient by applying an assignment rule or by executing a statistical evaluation process or a machine learning process that determines which delivery content resource is to be assigned to each recipient based on performance indicators of a plurality of types of the delivery content resources, to generate individualized delivery messages, and to transmit the individualized delivery messages via a communication network to an information delivery service device so that the individualized delivery messages are delivered to end users through an electronic communication service or a social network advertising service. This enables a computer system to more efficiently transform heterogeneous marketing and attribute data into structured generation feature data, to automatically construct optimized prompt sentences for interaction with a generative AI model, to generate and organize text and visual content in a machine-ready form, and to assign and deliver individualized messages to recipients in an integrated, processor-controlled pipeline, thereby improving processing throughput, reducing data conversion overhead, and enhancing overall system performance and reliability in content generation and delivery operations.

The term “market information” refers to information representing conditions or characteristics of a commercial environment, including, for example, distributions of consumer demographics, purchasing behaviors, product categories, and demand trends relevant to a target population.

The term “attribute information” refers to information representing characteristics of individuals or groups, including, for example, age, gender, interests, preferences, purchase history, and behavioral indicators used for segmentation and personalization.

The term “target population” refers to a set of recipients or users that share one or more common attribute conditions and are selected as a target for content generation and delivery in a campaign.

The term “information storage device” refers to a storage apparatus or subsystem, such as a database system or file storage system, that stores market information, attribute information, and related information in a machine-readable form.

The term “external information providing device” refers to an external system or service, such as an external database system, an application programming interface, or a data provider platform, that supplies additional information to the server via a communication network.

The term “related information” refers to information obtained from an information storage device and an external information providing device that is associated with, or derived from, market information and attribute information and is used for preprocessing and feature generation.

The term “information processing program” refers to a set of machine-executable instructions that cause a processor to perform data processing operations, including, for example, normalization, encoding, feature extraction, and other preprocessing tasks.

The term “normalization processing” refers to processing that scales or transforms numerical values, such as ages or purchase amounts, into a normalized range or distribution to improve numerical stability and comparability in subsequent computations.

The term “encoding processing” refers to processing that converts non-numerical or categorical values, such as gender or category labels, into numerical representations suitable for machine processing, for example by one-hot encoding or label encoding.

The term “feature extraction processing” refers to processing that derives feature values from raw data, including computing statistical values, aggregations, or derived indicators that characterize entities in a form usable by a generative AI model.

The term “generation feature data” refers to data structures, such as feature vectors or matrices, that result from preprocessing market information, attribute information, and related information and that are used as input to a generative AI model.

The term “tabular data structure” refers to a data structure that organizes data into rows and columns, such as a table or matrix, where each row represents an entity and each column represents a feature, enabling structured access and computation.

The term “missing value processing” refers to processing that handles absent or undefined data elements by operations such as filling with default values, imputing estimated values, or removing incomplete records.

The term “scale transformation of numerical features” refers to processing that modifies the scale or magnitude of numerical features, such as by standardization or min-max scaling, to normalize their range across a dataset.

The term “numerical representation conversion of categorical features” refers to processing that converts categorical or symbolic feature values into numerical form so that they can be used in mathematical and statistical operations.

The term “high-level instruction sentence” refers to a natural-language or symbolic instruction provided by a user that specifies an overall intent or goal for content generation without necessarily including detailed constraints or statistics.

The term “statistical information” refers to information derived from data by applying statistical operations, such as averages, medians, distributions, or frequency counts, to characterize a target population or dataset.

The term “preference information” refers to information that represents tendencies or inclinations of users or recipients, such as favored product types, preferred styles, or typical engagement behaviors.

The term “output format information” refers to information that defines structural or formatting requirements for generated content, including types of content to be output, length constraints, layout constraints, and media specifications.

The term “generative AI model prompt sentence” refers to a machine-readable instruction, derived from a high-level instruction sentence and additional information, that is provided as a prompt to a generative AI model to direct the generation of content.

The term “generative AI model” refers to a machine learning model or algorithm that is trained to generate new data instances, such as text, images, or other media, based on input prompts and feature data.

The term “content generation program” refers to a set of instructions executed by a processor that interacts with a generative AI model, supplies input prompts and feature data, and obtains generated content from the model.

The term “generated content” refers to content automatically produced by a generative AI model, including, for example, character information such as text and visual information such as images or design layouts.

The term “character information” refers to content expressed as sequences of characters or tokens, such as text messages, advertising phrases, email bodies, or other textual elements.

The term “visual information” refers to content expressed in a visual or graphical form, such as images, banners, layouts, or other graphical representations.

The term “postprocessing” refers to processing applied to generated content after it is produced by a generative AI model, including format conversion processing, component organization processing, and individual identification information assignment processing.

The term “format conversion processing” refers to processing that converts generated content from one format or representation to another, such as converting raw model outputs into standardized file formats or markup structures.

The term “component organization processing” refers to processing that arranges, groups, or structures elements of generated content, such as organizing text segments and visual elements into a template or layout.

The term “individual identification information assignment processing” refers to processing that associates generated content with identifiers, such as content IDs or campaign IDs, to enable management, tracking, and later retrieval.

The term “delivery content resources” refers to content units, including text and visual elements, that are prepared for delivery to recipients, possibly in association with templates or metadata.

The term “management information” refers to information associated with delivery content resources, such as identifiers, version information, campaign associations, generation parameters, and status indicators.

The term “terminal device” refers to an electronic device, such as a personal computer, smartphone, or tablet, that is configured to communicate with the server, display information, and receive user input.

The term “candidate selection operations” refers to user interactions performed via a terminal device to select or approve one or more delivery content resources from among multiple generated candidates.

The term “selected delivery content resources” refers to delivery content resources that have been approved or chosen by a user through candidate selection operations for use in actual message delivery.

The term “individualized delivery messages” refers to messages that are configured for particular recipients by combining selected delivery content resources with recipient-specific attribute information.

The term “information delivery service device” refers to an external system or service that distributes messages to recipients, such as an email delivery service, messaging service, or advertising platform.

The term “electronic communication service” refers to a service that delivers electronic messages, such as email, messaging, or similar communication services, over a communication network.

The term “social network advertising service” refers to a service provided by a social networking platform that distributes advertisements or sponsored content to users according to specified targeting parameters.

The term “assignment rule” refers to a rule or set of rules used by a processor to select, based on attribute information of a recipient, one delivery content resource from among multiple available delivery content resources.

The term “statistical evaluation process” refers to a process that evaluates performance indicators or outcomes of different delivery content resources using statistical methods to determine which resource should be assigned to a particular recipient or segment.

The term “machine learning process” refers to a computational process that uses a machine learning model to predict or determine, based on input features such as attribute information and performance indicators, which delivery content resource should be assigned to a particular recipient.

The term “performance indicators” refers to quantitative measures that represent the effectiveness of delivery content resources, such as open rates, click-through rates, conversion rates, or engagement metrics.

The term “communication network” refers to a wired or wireless network, including local area networks and wide area networks, that enables data communication between the server, external devices, and terminal devices.

In one embodiment, a server includes a processor, a main memory, a non-volatile storage device, a network interface, and, optionally, a graphics processing unit (GPU). The server communicates with one or more terminal devices operated by a user through a communication network. The terminal includes a display device, an input interface such as a keyboard or a touch panel, and a browser or a dedicated application. The user operates the terminal to interact with the server.

The server executes an operating system such as a general-purpose server operating system, and the server executes application software including a web application framework, a data processing library, and a machine learning framework. In a representative configuration, the server executes a web application implemented using a server-side scripting language and a web framework, and the server uses a relational database management system as an information storage device. The server further uses data processing libraries such as a tabular data processing library and a numerical computation library, and a machine learning framework such as a tensor computation framework or a tensor-based neural network framework. When image-based content is generated, the server uses an image processing library. The GPU, when present, is configured to accelerate matrix operations and tensor operations for a generative AI model.

The server stores market information and attribute information of a target population in a database in the information storage device. The server represents each entity, such as a potential recipient or a user segment, as a row in a table, and the server represents each attribute, such as age, gender, interest category, purchasing frequency, or past engagement score, as a column. The server also stores segment-level information, such as campaign identifiers and target conditions, in dedicated tables. The server configures foreign key relationships between tables, so that attribute records and segment definitions can be joined efficiently using indexed queries.

The terminal displays a graphical user interface implemented using HTML, a style description language, and a client-side scripting language. The user enters market information and attribute information through input fields, dropdown lists, checkboxes, and text areas.

The terminal validates the format of the input data, and the terminal sends the validated data to the server as structured messages, for example in a text-based structured format, over the network interface.

The server receives the market information and attribute information through an application programming interface endpoint implemented within the web framework. The server parses the received payload into an internal object representation, and the server constructs database commands that insert or update the corresponding rows in the database tables. The server assigns unique identifiers to new records, and the server logs timestamps and source identifiers for each transaction to maintain a consistent audit trail.

The server acquires related information from the information storage device and an external information providing device. In one embodiment, the server sends requests to external systems, such as customer data platforms or third-party data providers, over the communication network using an HTTP-based protocol. The external systems respond with additional data, such as inferred interests, propensity scores, or expanded demographic attributes. The server converts the external responses into the same tabular format used for internal data and stores them in auxiliary tables linked to the primary attribute tables.

The server merges internal and external data by executing join operations in the database or by loading the relevant tables into a tabular data processing library. The server constructs a tabular data structure, such as a DataFrame, in memory, in which each row corresponds to a recipient or entity, and each column corresponds to a feature candidate. The server performs missing value processing by applying deterministic rules, for example replacing missing numerical values with median values and missing categorical values with explicit “unknown” labels. The server applies scale transformation of numerical features by computing, for each numerical column, a mean and standard deviation or a minimum and maximum, and then computing normalized values using a formula such as (x−mean)/standard deviation or (x−min)/(max−min). The server stores the parameters used for normalization in a configuration structure, so that later processing stages can reverse or reuse the normalization consistently.

The server performs numerical representation conversion of categorical features by creating mappings from each categorical label to an integer index or to a one-hot vector. For example, the server maps a “gender” attribute to integer codes, and the server expands an “interest category” column into multiple binary columns, each representing presence or absence of a particular category. The server applies feature extraction processing by deriving additional features such as recency of last purchase, average order value, or engagement frequency. The server may compute rolling averages, counts over a time window, or weighted sums, using vectorized operations within the numerical computation library. The server thus generates generation feature data, which the server stores as a matrix of numerical values, with dimensions corresponding to entities and features.

The server stores the generation feature data in memory for immediate use, and, in some embodiments, the server writes the feature data to a high-speed cache or a dedicated feature store. By structuring the data as a contiguous numerical matrix, the server improves cache locality and reduces overhead in transferring data to the GPU memory. This structure enables efficient batch processing when invoking the generative AI model, thereby improving throughput and reducing latency compared to naïve row-by-row processing.

The terminal provides an input area for a high-level instruction sentence (prompt sentence). The user describes an intended campaign or creative direction in natural language. For example, the user may enter:

“Generate a social media ad with a bold visual and short copy for men in their 30s who like running and high-performance sports shoes.” or “Create an email promotion for women in their 20s who enjoy yoga and eco-friendly lifestyle products.”

The terminal sends the high-level instruction sentence together with a reference to the relevant target segment to the server.

The server receives the high-level instruction sentence, and the server retrieves the corresponding generation feature data and related statistics from the tabular data structure.

The server computes statistical information of the target population, such as average age, most frequent interest categories, distribution of spending levels, and typical engagement rates. The server also determines preference information by analyzing feature distributions, for example by identifying the top-ranked product categories or common behavioral patterns.

The server determines output format information based on the campaign type, such as whether a social media ad, an email newsletter, or another type of content is requested. The server stores format definitions, such as maximum text length, required number of variants, and required image resolution, in configuration tables.

The server generates a generative AI model prompt sentence by expanding the high-level instruction sentence. The server concatenates or interpolates the high-level instruction sentence with the computed statistical information, preference information, and output format information into a structured natural-language instruction. For instance, when the user enters “Generate a social media ad with a bold visual and short copy for men in their 30s who like running and high-performance sports shoes,” the server may construct the following detailed prompt sentence:

“Act as a professional marketing designer. Create a social media ad concept for high-performance running shoes. Target audience: men in their 30s with an average age of 34, primarily interested in running and fitness, with a history of purchasing premium sports products. Include: (1) one bold and energetic visual design description suitable for a square image, resolution 1080×1080, and (2) three concise ad copy lines under 15 words each.” Similarly, when the user enters “Create an email promotion for women in their 20s who enjoy yoga and eco-friendly lifestyle products,” the server may construct:

“You are a marketing copywriter. Write an email promotion for a sustainable yoga apparel brand. Target: women in their 20s who practice yoga at least twice per week, with a strong preference for eco-friendly and ethically produced products. Include: (1) a warm, personalized greeting, (2) a short description of key product benefits focusing on sustainability and comfort, and (3) a limited-time eco-friendly themed offer. Keep the total length under 250 words.”

The server logs the high-level instruction sentence, the generated generative AI model prompt sentence, and identifiers of the associated generation feature data in a prompt history repository, enabling reproducibility and later analysis. Because the server deterministically derives prompt expansions from well-defined feature statistics, the behavior of the system becomes more stable and predictable than simple pass-through prompting, thereby improving consistency and reducing the number of model calls required to achieve acceptable outputs.

In one embodiment, the server implements the generative AI model as a neural network running on the machine learning framework. For text generation, the server uses a transformer-based language model comprising an embedding layer, multiple self-attention layers, and feed-forward layers. The server initializes the model with parameters pre-trained on large text corpora, and, in some embodiments, the server fine-tunes the model using domain-specific marketing data stored in the information storage device. For image generation, the server uses a generative model such as a diffusion-based network, which iteratively denoises latent representations to produce images. The server configures the model with a specified number of layers, hidden dimensions, and attention heads, and the server stores these hyperparameters in configuration records.

The server encodes the generative AI model prompt sentence into token sequences using a tokenizer, such as a subword tokenizer, and the server converts the generation feature data into an auxiliary conditioning vector. The server concatenates, fuses, or otherwise conditions the token embeddings with the feature vectors. For example, the server may append a special segment to the input sequence that encodes aggregated feature values as pseudo-text tokens, or the server may feed the feature vectors through a separate dense layer and inject the resulting conditioning vector into the model via cross-attention or bias terms. This conditioning mechanism permits the model to adapt its output to the actual distribution of the target population, beyond what is expressed in the natural-language prompt alone.

The server executes the generative AI model on the processor and, when available, offloads matrix multiplications and attention computations to the GPU. The server performs inference by applying forward passes through the transformer layers with a decoding algorithm such as beam search or nucleus sampling, using parameters such as temperature and maximum token length stored in configuration. For image generation, the server performs a series of denoising steps according to the diffusion schedule, guided by the conditioning vectors. The server receives the generated token sequences and, when applicable, generated image tensors as outputs.

During training or fine-tuning phases, the server updates the model parameters by computing a loss function, such as cross-entropy loss for language modeling or a noise-prediction loss for diffusion models, and the server applies a gradient-based optimization algorithm such as stochastic gradient descent or an adaptive optimizer. The server computes gradients by backpropagation through the layers and updates weights according to the chosen learning rate schedule. The server may apply data augmentation methods, such as random truncation of prompts or synthetic variation of attribute features, to improve robustness. These operations occur under explicit control of the processor and are not limited to merely automating human writing; instead, they restructure how the computer represents prompts and features so that the hardware can more efficiently and accurately generate tailored outputs.

The server performs postprocessing on the generated content. For text, the server decodes the token sequences into character strings, removes control tokens, and enforces length constraints. The server segments the text into logical components, such as headline, subheadline, and body paragraphs, based on special markers or position rules. For images, the server converts tensors into standard image formats using the image processing library and assigns filenames or object identifiers. The server stores the generated content in a content repository, associating each item with metadata including campaign ID, model configuration, time of generation, and evaluation scores.

The server performs component organization processing by inserting the generated text and image references into predefined templates for email bodies, social media posts, or other channels. The server maintains templates in a template library, with placeholders for dynamic content. The server fills these placeholders with the generated content in a structured manner, thereby producing delivery content resources. The server assigns unique identifiers to each delivery content resource and records management information such as version numbers, language, and channel type.

The terminal retrieves lists of delivery content resources and displays them to the user. The terminal presents thumbnails of images, preview renderings of email layouts, and text blocks of generated copy. The user interacts with the terminal to approve or reject candidates and to select one or more delivery content resources for use. The terminal sends identifiers of the selected resources to the server.

The server receives the selections and marks the corresponding resources as selected delivery content resources in the database. The server then prepares for individualized delivery. The server acquires, from the information storage device, lists of recipients belonging to the target population, including their attribute information and contact information. The server computes assignment decisions for each recipient. In one embodiment, the server applies simple assignment rules stored in a rule table, such as “assign variant A to recipients aged 30-34 and variant B to recipients aged 35-39.” In another embodiment, the server executes a statistical evaluation process that uses previously logged performance indicators of each variant, such as open rates and click-through rates, and computes, for each recipient segment, which variant maximizes an expected performance metric. In yet another embodiment, the server uses a machine learning model, such as a gradient-boosted tree or a neural network classifier, that receives recipient attributes and variant descriptors as input features and outputs a score for each variant; the server selects the variant with the highest score.

The server generates individualized delivery messages by combining the selected delivery content resource with recipient-specific data, such as the recipient name or previously purchased items, using string interpolation and template filling. The server constructs message payloads in standardized formats, such as email message formats or advertising creative configurations, and the server populates tracking parameters to measure subsequent performance. The server batches messages and transmits them via the network interface to information delivery service devices, such as email transmission services or social network advertising platforms. The server uses application programming interfaces or messaging protocols to submit the messages, and the server records transaction IDs and status codes returned by those services.

The system as implemented yields technical effects beyond mere automation of human creative work. By structuring attribute and market data as normalized numerical feature matrices and using them to systematically expand high-level prompts into detailed, model-optimized prompt sentences, the server reduces the number of iterations needed to obtain acceptable generative outputs, thereby reducing network traffic between the server and external services and reducing GPU computation time per campaign. The normalization and encoding of features improve numerical stability and memory locality, resulting in faster matrix multiplications and reduced cache misses. The integrated pipeline from data acquisition, through prompt expansion and generative processing, to individualized assignment and delivery reduces intermediate file transfers and format conversions, which improves overall processing throughput and decreases storage overhead.

Moreover, the generative AI model in this system is not used as a black box that replaces a human author; instead, the server explicitly controls the model architecture, conditioning method, and feature integration. By injecting structured feature vectors into the model inputs and by managing model hyperparameters and decoding algorithms at the processor level, the system improves the alignment of generated outputs with measured performance indicators in a way that is not achievable by a manual workflow or by a simple template engine. The system therefore constitutes an improvement in computer technology related to data representation, model interfacing, and content distribution control.

In alternative embodiments, the server may use different neural network architectures for the generative AI model, such as recurrent neural networks, convolutional sequence models, or hybrid architectures combining transformers with convolutional encoders. The server may also use different loss functions, such as sequence-level reinforcement learning objectives that directly optimize deployment metrics, or ranking losses that favor variants associated with higher engagement. The server may compress models using techniques such as quantization or pruning to reduce memory usage and improve inference latency. The terminal may be implemented as a native mobile application instead of a web browser, and the information storage device may be implemented using a distributed key-value store rather than a single relational database system.

In all such embodiments, the server, the terminal, and the user interact in a manner consistent with the generative AI model, the prompt sentence generation, and the feature-based conditioning described above. The essential feature is that the server systematically transforms heterogeneous input data into structured generation feature data, uses that data to generate an expanded generative AI model prompt sentence, executes a generative AI model under explicit, feature-aware control, and assigns resulting delivery content resources to individual recipients in a unified computational pipeline that improves the technical performance of the computer system.

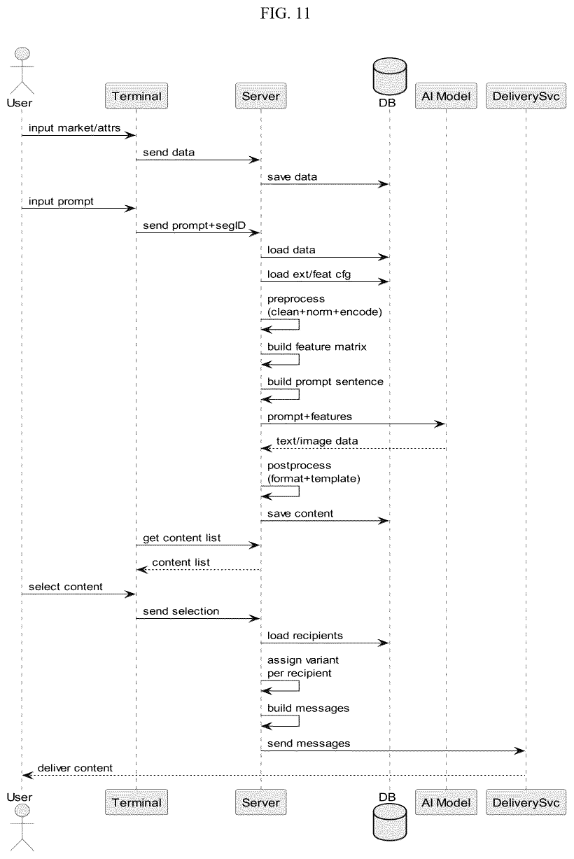

The following describes the processing flow using FIG. 11.

### Step 1:

The terminal displays an input screen including fields for market information and attribute information of a target population.

The user inputs values such as age range, gender, interest categories, purchase history summaries, and campaign type into the fields on the terminal.

The terminal validates the format of the input values, and the terminal transmits the validated data to the server as a structured request over a communication network.
Input: raw user-entered market information and attribute information on the terminal.
Output: a structured request message containing market information and attribute information sent from the terminal to the server.

### Step 2:

The server receives the structured request message from the terminal through a web application interface.

The server parses the request message into internal data objects and generates database commands to insert or update records in tables that store market information, attribute information, and campaign identifiers.

The server commits these records to an information storage device and assigns unique identifiers to newly created entities, such as a campaign ID and a segment ID.
Input: structured request message including market information and attribute information.
Output: persisted database records representing the market information, attribute information, and associated campaign metadata.

### Step 3:

The server acquires related information by reading stored records from the information storage device and by sending requests to an external information providing device via the communication network.

The server receives external responses containing additional attributes, such as inferred interests or propensity scores, and converts the external data into the same schema as internal records.

The server merges internal and external data by performing keyed joins on identifiers such as user IDs or contact IDs, thereby forming a unified tabular representation in memory.
Input: database records of market information and attribute information, and external data responses.
Output: a unified tabular data structure containing combined internal and external attribute fields for each entity.

### Step 4:

The server performs missing value processing on the unified tabular data structure by scanning each column for undefined entries and applying predetermined rules to fill or mark missing values.

The server applies scale transformation to numerical columns, such as age and purchase frequency, by computing statistical parameters (for example, mean and standard deviation) and then transforming each value according to a normalization formula.

The server converts categorical columns, such as gender or interest category, into numerical representations by assigning integer codes or generating one-hot encoded vectors, and the server appends derived features such as aggregated purchase metrics.
Input: unified tabular data structure with raw numerical and categorical fields.
Output: a cleaned and numerically encoded tabular data structure ready for feature extraction.

### Step 5:

The server performs feature extraction processing by selecting relevant columns, computing derived indicators, and assembling them into a dense numerical matrix, wherein rows correspond to entities and columns correspond to features.

The server stores normalization parameters, encoding mappings, and selected feature indices in configuration data so that the same transformations can be reused consistently.

The server designates the resulting numerical matrix as generation feature data and retains it in memory or caches it for subsequent model processing.
Input: cleaned and numerically encoded tabular data structure.
Output: generation feature data represented as a numerical feature matrix and associated transformation parameters.

### Step 6:

The terminal presents a text input field for a high-level instruction sentence, indicating the type of content the user wants the system to generate.

The user types a natural-language description, such as “Generate a social media ad with a bold visual and short copy for men in their 30s who like running and high-performance sports shoes,” into the input field.

The terminal transmits the high-level instruction sentence together with a reference to the campaign or segment ID to the server.
Input: user-entered high-level instruction sentence on the terminal.
Output: a request message containing the high-level instruction sentence and a reference to the target segment sent to the server.

### Step 7:

The server receives the high-level instruction sentence and the segment reference and retrieves the corresponding generation feature data and related records from the information storage device.

The server computes statistical information, such as average age, dominant interest categories, and spending level distribution, for the target population represented in the generation feature data.

The server determines preference information and output format information by analyzing campaign configuration records and feature distributions.
Input: high-level instruction sentence, campaign or segment reference, and generation feature data.
Output: computed statistical information, preference information, and output format information associated with the target population.

### Step 8:

The server generates a generative AI model prompt sentence by expanding the high-level instruction sentence using the computed statistics, preferences, and format requirements.

The server concatenates descriptive clauses, inserts numerical values such as average age, and specifies constraints such as maximum word counts and required number of variants, thereby forming a detailed model-oriented instruction.

The server logs the high-level instruction sentence and the expanded generative AI model prompt sentence along with identifiers of the associated generation feature data in a prompt history record.
Input: high-level instruction sentence, statistical information, preference information, and output format information.
Output: an expanded generative AI model prompt sentence suitable for input to a generative AI model, and a stored prompt history entry.

### Step 9:

The server encodes the generative AI model prompt sentence into token identifiers using a tokenizer associated with a transformer-based language model.

The server prepares the generation feature data as a conditioning vector by applying any necessary dimensionality reduction or projection to align it with the model's conditioning interface.

The server constructs model input structures by combining token embeddings derived from the prompt sentence with the conditioning vectors, for example by appending special tokens or by supplying the conditioning vectors to dedicated input layers.
Input: generative AI model prompt sentence and generation feature data.
Output: encoded token sequences and conditioning vectors arranged as input tensors for the generative AI model.

### Step 10:

The server executes the generative AI model on a machine learning framework, optionally offloading tensor computations to a GPU to accelerate matrix multiplications and attention operations.

The server performs an inference process by applying the model's forward pass with decoding parameters such as maximum token length, temperature, and sampling strategy, thereby generating sequences of token identifiers representing textual content.

When visual content is requested, the server also executes a generative image model, such as a diffusion-based neural network, by iteratively denoising latent representations conditioned on the same feature vectors and textual prompt embeddings.
Input: model input tensors containing encoded prompt tokens and conditioning vectors.
Output: generated token sequences for textual content and, when applicable, image tensors or latent representations for visual content.

### Step 11:

The server decodes the generated token sequences into character strings, removes control tokens, and enforces formatting constraints such as length limits and required segment structures.

The server converts image tensors or latent representations into standard image files by applying de-normalization, color-space conversion, and encoding operations using an image processing library.

The server stores the generated text and image data in a content repository, associating each item with metadata including campaign ID, model configuration, and generation time.
Input: generated token sequences and image tensors from the generative AI model.
Output: human-readable text strings, rendered image files, and corresponding metadata records.

### Step 12:

The server performs component organization processing by inserting generated text and images into predefined templates for messages, such as email layouts or social media post structures.

The server fills placeholders in the templates with generated headlines, body text, and image references, and the server verifies that the resulting compositions satisfy channel-specific constraints such as character limits and image aspect ratios.

The server defines each composition as a delivery content resource and generates management information including unique identifiers, version numbers, channel type, and status.
Input: generated text and images, and predefined message templates.
Output: structured delivery content resources and associated management information stored in a repository.

### Step 13:

The terminal requests a list of available delivery content resources for a selected campaign.

The server retrieves the corresponding delivery content resources and management information from the repository and returns them to the terminal as a structured response.

The terminal renders previews of the content resources, including visual thumbnails and text segments, enabling the user to review and compare different variants.
Input: campaign selection request issued by the terminal.
Output: displayed previews of delivery content resources and their management information on the terminal.

### Step 14:

The user reviews the previews displayed on the terminal and selects one or more preferred delivery content resources using selection controls such as buttons or checkboxes.

The terminal transmits identifiers of the selected delivery content resources back to the server as a selection message.

The server updates the status of the selected resources in the management information to indicate that they are approved for delivery.
Input: user selection operations performed on the terminal.
Output: selected delivery content resource identifiers and updated management records in the server.

### Step 15:

The server retrieves attribute information and contact information for individual recipients belonging to the target population from the information storage device.

The server determines, for each recipient, which selected delivery content resource should be assigned, by applying assignment rules, statistical evaluation processes, or machine learning models that consider recipient attributes and historical performance indicators.

The server records, for each recipient, the identifier of the chosen delivery content resource, forming an assignment map that links recipients to specific content variants.
Input: selected delivery content resources, recipient attribute information, and performance indicators of content variants.
Output: an assignment map specifying a delivery content resource for each recipient.

### Step 16:

The server generates individualized delivery messages by combining the assigned delivery content resource with recipient-specific data, such as name and prior purchase references, using template filling and string interpolation.

The server formats the individualized messages according to channel specifications, such as generating compliant email messages or advertisement payloads required by social network platforms.

The server queues the individualized messages for transmission and then sends them through the communication network to information delivery service devices, which in turn deliver the messages to end users via electronic communication services or social network advertising services.
Input: assignment map, selected delivery content resources, and recipient-specific data.
Output: transmitted individualized delivery messages delivered to end users through external information delivery services.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented content delivery systems, the generation and distribution of personalized advertisements or other user-facing content is typically performed by executing a series of loosely coupled modules, such as rule-based targeting engines, template-based content generators, and messaging subsystems. In many cases, user attributes and context information are merely inserted into static templates, and generative artificial intelligence models, if used at all, are invoked with fixed or manually crafted prompts that do not fully exploit available user interaction data or model capabilities. As a result, existing systems suffer from several technical problems.

First, conventional platforms do not efficiently translate heterogeneous input data such as market information, target user information, user attribute information, and user interaction logs into machine-interpretable prompt sentences suitable for generative artificial intelligence models. This causes suboptimal utilization of computational resources in the generative models, increased latency in content generation, and a need for repeated manual prompt engineering, thereby degrading system scalability and responsiveness in large-scale deployments.

Second, many known systems treat the generative model as a black box that is invoked in isolation, without a structured feedback loop from downstream user interactions. Generated advertisements or other content are delivered to user terminals, but viewing information and operation information (for example, impressions, clicks, and other interaction events) are not systematically propagated back to update prompt construction logic or generation conditions of the generative models. Consequently, the computing pipeline does not adapt at the system level, leading to inefficient reuse of computationally expensive generations and inability to automatically tune model behavior for improved performance.

Third, conventional architectures often lack an integrated mechanism for representing model outputs as structured data that can be processed in subsequent stages of the pipeline. For example, visual information produced by a generative model may be returned as unstructured text, requiring ad hoc parsing or human intervention before being converted into image generation inputs or layout instructions. This causes additional computation, error-prone processing, and increased latency across the content delivery path.

Fourth, typical systems handle terminal-facing delivery as an afterthought, simply pushing raw content to endpoints without a unified representation that can be flexibly converted for different delivery media. As a result, it is difficult to efficiently generate and distribute consistent personalized content across heterogeneous endpoints, including portable information terminals, print media, and other display media, using the same underlying computational pipeline.

Accordingly, there is a need for an improved computer-implemented system that (i) programmatically constructs and encodes prompt sentences for generative artificial intelligence models based on multi-source input data including user attributes and emotion analysis results, (ii) structures generated character information and visual information as advertisement information data suitable for downstream processing, (iii) tightly integrates a messaging infrastructure and terminal-side interaction capture into a closed feedback loop, and (iv) uses that feedback to update prompt sentences and generation conditions of the generative artificial intelligence models. Such a system improves the technical functioning of the content generation and delivery pipeline itself by reducing manual intervention, improving computational efficiency, and enhancing adaptability of model-driven content generation at scale.

The specific processing by the specific processing unit 290 of the data processing device 12 in Application Example 1 is realized by the following means.

The present invention provides a server comprising a processor configured to acquire market information and target user information, obtain attribute information of a user based on the target user information, and perform emotion analysis to recognize an emotional state of the user based on the market information and the target user information; dynamically construct a prompt sentence for causing a generative artificial intelligence model to generate character information and visual information, based on the market information, the target user information, the attribute information, and a result of the emotion analysis, encode the prompt sentence into an input format acceptable to the generative artificial intelligence model, and input the encoded prompt sentence to the generative artificial intelligence model; construct advertisement information data based on the character information and the visual information output from the generative artificial intelligence model, convert the advertisement information data into notification data for transmission to a portable information terminal via a messaging infrastructure, and, in response to a request from the portable information terminal and based on identification information included in the notification data, distribute the advertisement information data so that the character information and the visual information are presented as personalized display content on the portable information terminal; analyze, as structured data including at least one of a color attribute, a layout attribute, and an image concept attribute, the visual information output from the generative artificial intelligence model, generate image-generation text information for input to an image generation model based on the structured data, and store image data generated by the image generation model in association with the advertisement information data; convert the advertisement information data into at least one of electronic notification data, print data, and external output data according to a distribution medium, use the electronic notification data for push-type distribution to the portable information terminal, and edit the print data and the external output data into a format outputtable as an advertising medium, a distribution medium, or a display medium; and acquire viewing information or operation information relating to the personalized display content from the portable information terminal and update at least one of the prompt sentence and generation conditions of the generative artificial intelligence model based on the viewing information or the operation information. This enables the computer-implemented content generation and delivery pipeline to automatically construct model-ready prompt sentences from heterogeneous input data, to represent generated outputs as structured advertisement information data usable across multiple media, and to adaptively refine generative behavior through a closed feedback loop, thereby improving computational efficiency, scalability, and responsiveness of the underlying computer system.

The term “market information” refers to data representing conditions or trends in a commercial environment, including, for example, product categories, demand indicators, pricing trends, seasonal factors, and segmentation parameters used for determining target audiences.

The term “target user information” refers to data identifying one or more intended recipients of content, including, for example, user identifiers, targeting rules, and selection criteria used to associate a user with one or more campaigns.

The term “attribute information” refers to descriptive data associated with a user, including, for example, age, gender, interests, purchase history, device identifiers, and other profile-related parameters.

The term “emotion analysis” refers to computational processing performed by the processor to determine an emotional state or sentiment of a user from input data, such as textual, behavioral, or contextual data, using predetermined rules or machine learning models.

The term “emotional state” refers to an inferred condition of user sentiment, such as happiness, interest, dissatisfaction, excitement, or neutrality, represented in a form usable by the processor for subsequent processing.

The term “prompt sentence” refers to machine-interpretable textual information constructed by the processor to describe a generation request and contextual conditions, and supplied as input to a generative artificial intelligence model for causing the model to generate output content.

The term “generative artificial intelligence model” refers to a computational model implemented by software and executed on hardware, which produces character information, visual information, or other content in response to input data such as a prompt sentence.

The term “character information” refers to text data generated or processed by the system, including, for example, titles, body text, slogans, and call-to-action phrases used in content presented to a user.

The term “visual information” refers to data representing visual aspects of content, including, for example, descriptions of colors, layouts, image concepts, or other design elements, which may be used to generate or render images or graphical layouts.

The term “advertisement information data” refers to structured data constructed by the processor, including character information, visual information, identifiers, and associated metadata, and representing a unit of content intended for distribution to a user.

The term “notification data” refers to data derived from advertisement information data and formatted for transmission via a messaging infrastructure, including, for example, notification titles, bodies, identifiers, and auxiliary parameters required for delivery to a terminal.

The term “messaging infrastructure” refers to one or more communication services, protocols, or systems that deliver notification data from the server to a portable information terminal using network-based messaging mechanisms.

The term “portable information terminal” refers to an electronic device capable of wireless communication and user interaction, such as a smartphone, tablet, or other handheld computing device, that receives and displays content.

The term “personalized display content” refers to content presented on a portable information terminal, where at least a portion of the content, including character information or visual information, is determined based on attribute information, target user information, or other user-specific data.

The term “viewing information” refers to data indicating how content is displayed or observed on a terminal, including, for example, impression events, display duration, scroll behavior, or screen exposure metrics.

The term “operation information” refers to data indicating user interactions with content, including, for example, taps, clicks, selections, dismissals, or other input operations performed via a terminal interface.

The term “generation conditions” refers to parameters used to control operation of a generative artificial intelligence model, including, for example, temperature, sampling strategy, maximum length, style indicators, or conditioning attributes.

The term “structured data” refers to data that is organized in a predefined schema or format, such as key-value pairs, lists, or tabular representations, enabling deterministic parsing and processing by the processor.

The term “color attribute” refers to data representing one or more color-related properties of visual content, including, for example, primary colors, accent colors, or color codes used in a design.

The term “layout attribute” refers to data indicating arrangement or positioning of elements in visual content, including, for example, relative placement of images, text blocks, and interactive elements.

The term “image concept attribute” refers to data describing semantic or conceptual aspects of an image, including, for example, subject matter, scene description, style, or mood, which may be used as input for image generation.

The term “image-generation text information” refers to textual data constructed by the processor to describe desired visual characteristics of an image, and provided as input to an image generation model for producing image data.

The term “image generation model” refers to a computational model that generates image data in response to input information, such as image-generation text information, using learned parameters and image synthesis algorithms.

The term “image data” refers to digital data representing an image, including, for example, pixel values, encoded image files, or references to stored image resources.

The term “electronic notification data” refers to advertisement information data that has been formatted for electronic push-type delivery to a terminal, including notification payloads, identifiers, and control parameters used by a messaging infrastructure.

The term “print data” refers to advertisement information data converted into a format suitable for physical printing, including layout information, high-resolution images, and text arranged for a printed medium.

The term “external output data” refers to advertisement information data converted into a format suitable for output to external systems or devices, such as digital signage, web-based displays, or third-party distribution platforms.

The term “advertising medium” refers to a physical or electronic medium used to present advertisement content to users, including, for example, printed materials, digital banners, or display screens.

The term “distribution medium” refers to a medium or channel through which advertisement information is delivered, including, for example, network-based services, physical distribution channels, or broadcast systems.

The term “display medium” refers to any device or surface capable of visually presenting content to a user, including, for example, screens, monitors, projectors, or printed surfaces.

In one embodiment, a server, a plurality of terminals, and one or more networks constitute a system for generating and delivering personalized content using a generative AI model driven by dynamically constructed prompt sentences. The server includes at least one processor, a main memory, a non-volatile storage device, a network interface, and an optional hardware accelerator such as a graphics processing unit. The terminal includes a processor, a display device, a memory, a network communication module, and an input interface such as a touch panel.

The server executes system software such as an operating system and middleware, as well as application software that implements prompt construction, AI-based content generation, advertisement information management, and communication with the terminal. The server uses a programming language runtime to execute application logic and employs a machine learning framework such as a tensor-based computation library (for example, a neural network library) to execute the generative AI model. The server further uses a database management system to store user data, advertisement information data, and interaction logs.

The terminal executes a native application or a web-based application that communicates with the server and displays personalized display content. The terminal uses an operating system for mobile devices and a software development kit for receiving push notifications and rendering user interfaces. The user operates the terminal via the touch panel or other input means to view and interact with the personalized display content.

The server stores records of market information and target user information in the database using structured data models, such as tables having fields for campaign identifiers, product categories, target age ranges, and other segmentation parameters. The server also stores user attribute information, including user identifiers, demographic attributes, stated interests, and purchase histories. The server associates users with campaigns via relational links or index structures so that a given user can be efficiently matched to one or more campaigns based on predefined targeting rules.

The server implements an emotion analysis module as software executed by the processor.

The server uses this module to derive an emotional state of a user from one or more input sources, such as textual feedback, historical interaction logs, or context data associated with the campaign. In one embodiment, the server uses a neural network model for emotion classification, implemented as a multi-layer network that takes text tokens or numerical features as input and outputs a probability distribution over several emotion classes. The server trains this model using supervised learning with labeled datasets, employs a loss function such as cross-entropy loss, and updates model weights using an optimization algorithm such as stochastic gradient descent or a variant thereof. The server improves classification accuracy and robustness by applying regularization techniques and data augmentation methods, such as synonym replacement in text or minor perturbations of feature values.

The server constructs prompt sentences based on market information, target user information, user attribute information, and the emotion analysis result. The server uses a dedicated prompt construction module that executes deterministic algorithms on structured data to generate natural language instructions tailored for the generative AI model. The server uses template structures and rule-based transformations, rather than simply concatenating raw data, to ensure that the prompt sentence encodes relevant context and constraints in a machine-optimized manner. For example, the server may first normalize attribute values (e.g., mapping internal codes to descriptive phrases), then apply ordering rules to decide the sequence in which user attributes, campaign context, and desired tone are mentioned, and finally apply formatting rules to ensure the generative AI model receives a consistent style of instructions.

The server, in one example, constructs a prompt sentence such as:

“The user is a 25-year-old female who recently purchased sports equipment online. Generate a personalized advertisement text and a simple visual design concept for new running shoes, using an energetic and motivational tone.”

In another example, the server constructs a prompt sentence such as:

“User: 30-year-old male, interested in gaming and streaming, frequently buys gaming accessories. Generate a personalized advertisement text and visual design concept for a new gaming headset, with a bold, high-tech style.”

The server encodes each prompt sentence into a token sequence using a tokenizer compatible with the generative AI model. The server maps each token to an integer index, constructs attention masks, and performs padding or truncation to a fixed input length. By standardizing input sequences in this manner, the server enables efficient batch computation on the generative AI model, thereby reducing processing latency and improving throughput in large-scale scenarios.

The server executes the generative AI model on the processor and, when available, on the hardware accelerator to improve computation speed. In one embodiment, the generative AI model is a Transformer-based neural network comprising an embedding layer, multiple self-attention layers, feed-forward layers, and an output projection layer. The server stores in memory a set of model parameters representing learned weights and biases for each layer.

The server obtains character information and visual information by performing autoregressive generation: at each generation step, the server feeds the current token sequence to the model, obtains a probability distribution over possible next tokens, selects or samples a next token according to generation conditions (such as temperature, top-k, or top-p parameters), and appends the selected token to the sequence. This process continues until a termination condition, such as reaching a maximum length or encountering a special end token, is met.

The server does not merely automate human copywriting; rather, the server uses the generative AI model and structured prompt sentences to efficiently explore a high-dimensional space of content variations that would be impractical for human operators to enumerate. The server adjusts sampling parameters and internal constraints based on feedback data, thereby improving not just the content itself but the underlying computational pipeline. The server, for example, can reduce redundant generations by caching model outputs associated with specific prompt configurations and reusing them when compatible conditions arise, thus reducing computation time and network bandwidth.

The server parses the output of the generative AI model into character information and visual information. The server treats visual information as structured data, such as a dictionary containing keys for color attributes, layout attributes, and image concept attributes. The server uses syntax rules and pattern matching to separate descriptive phrases into these components. For instance, if the generative AI model outputs a sentence such as “Use a bright orange main color, white accent color, and a layout with a large hero image at the top and a call-to-action button at the bottom, showing a woman running in a city park at sunrise,” the server extracts “bright orange” as the main color attribute, “white” as the accent color attribute, “large hero image at the top and call-to-action button at the bottom” as the layout attribute, and “woman running in a city park at sunrise” as the image concept attribute. The server stores these attributes as structured data in the database.

The server, in one embodiment, uses the visual information to generate input for an image generation model. The server constructs image-generation text information by reformulating the image concept and design attributes into a concise prompt specialized for the image generation model. For example, the server may generate image-generation text information such as:

“Generate an image of a woman running in a city park at sunrise, using bright orange as a dominant color and a style suitable for a sports advertisement.”

The server inputs this text information to the image generation model, which may be implemented as a diffusion-based or generative adversarial network architecture. The server executes the model using the hardware accelerator to efficiently generate image data. The server stores the generated image data in a storage device and registers a reference, such as a uniform resource identifier, in the database so that the image can be retrieved later when constructing advertisement information data.

The server constructs advertisement information data by combining the character information, the visual information, and any associated image data references. The server uses a structured representation, such as a record containing fields for a title, body text, call-to-action text, main color attribute, layout attribute, and image location. This structured representation enables the server to adapt the same advertisement information to different distribution media. For example, the server can derive a compact text version suitable for push notifications, a rich layout suitable for in-app display on the terminal, and a high-resolution printable layout for physical media, all from the same underlying advertisement information data.

The server converts the advertisement information data into notification data for use with a messaging infrastructure. The server forms a payload that includes a notification title, a notification body, and identification information such as an advertisement identifier. The server uses the network interface to transmit this notification data through a push messaging service to the terminal. By performing this conversion on the server-side, the system reduces processing load on the terminal and ensures consistent formatting and identification of notifications across different devices.

The terminal receives notification data via the messaging infrastructure and displays a notification to the user, for example, in the notification area of the operating system. The user selects the notification, and the terminal initiates a request to the server using the identification information contained in the notification data. The terminal receives the advertisement information data from the server and renders personalized display content using its display device. The terminal creates a screen layout in which the title, body text, call-to-action, and image are arranged according to the layout attribute and the color attributes specified in the advertisement information data. The terminal benefits from the structured nature of the data, as it can directly map attributes to user interface components without performing heavy parsing or heuristic interpretation.

The user views the personalized display content on the terminal and may perform one or more operations, such as tapping a call-to-action button, scrolling, or dismissing the content.

The terminal records viewing information, such as the duration for which the content remains in the foreground, and operation information, such as which interactive elements are activated. The terminal sends this interaction data to the server in a compact, structured format to minimize communication overhead.

The server receives the viewing information and operation information and stores it in the database as feedback data linked to the corresponding advertisement identifier, user identifier, and campaign identifier. The server periodically or continuously analyzes this feedback data to update prompt sentences and generation conditions of the generative AI model. For instance, the server may detect that advertisements generated with a specific tone achieve higher interaction rates for a given user segment and therefore adjust future prompt sentences to emphasize that tone. The server may also adjust model parameters such as maximum generation length or sampling temperature to reduce verbosity or increase diversity based on observed user behavior. By directly coupling user interaction data with the internal configuration of the prompt construction and generation modules, the system forms a closed feedback loop that improves the efficiency and quality of future generations.

The server, in one embodiment, uses an optimization procedure to tune prompt templates and generation conditions. The server defines an objective function that increases with positive interaction metrics, such as click-through rate or time spent viewing content. The server then systematically varies parameters of the prompt templates and generation conditions and evaluates their impact on the objective function. The server may use bandit algorithms or reinforcement learning techniques to identify parameter settings that improve performance, thereby reducing the need for manual tuning and achieving technical improvements in system responsiveness and resource utilization.

The server achieves technical advantages over conventional approaches in several ways. By constructing structured prompt sentences that encode both user attributes and emotion analysis results, the server increases the relevance and efficiency of generative AI model calls, reducing wasted computation on poorly specified prompts. By representing the model outputs as structured advertisement information data and extracting explicit visual attributes, the server enables downstream modules to perform deterministic, rule-based rendering across multiple media, which reduces runtime errors, simplifies client-side logic, and allows for optimized caching and re-use. By integrating the messaging infrastructure and terminal feedback into the same computational pipeline, the server can automatically reconfigure prompt sentences and generation conditions based on large-scale interaction data, leading to improved accuracy of targeting and reduced latency for content generation and delivery.

The terminal benefits from offloading heavy computation to the server. Because the terminal receives structured advertisement information data and pre-processed image references, the terminal only needs to perform lightweight rendering on the display device. This reduces power consumption and processing load on the terminal, which is particularly important for portable information terminals with limited resources. Furthermore, the terminal transmits only compact feedback data to the server, minimizing network traffic and improving responsiveness in mobile network environments.

The user, in turn, experiences content that is better aligned with their interests and context because the system uses fine-grained attribute information, emotion analysis, and interaction-based feedback to guide the generative AI model. The user does not need to explicitly provide detailed preferences for each advertisement or content item; rather, the system learns and refines underlying patterns from aggregated behavior and structured interaction logs.

In alternative embodiments, the server may use different types of neural network architectures for the generative AI model, such as recurrent neural networks or hybrid architectures combining convolutional and attention-based layers. The server may implement the emotion analysis function using a separate model tailored to speech signals or multimodal inputs, such as audio combined with textual data. The server may also vary the structure of the advertisement information data to include additional metadata, such as device capability indicators, network condition indicators, or accessibility-related attributes, enabling further optimization of how content is rendered on different terminals.

In another variation, the server may apply compression and encoding schemes to the structured advertisement information data and image data, thereby reducing communication load between the server and terminals. The server can choose encoding formats adaptively based on network conditions or device capabilities, further improving technical performance. In yet another embodiment, the server may schedule or prioritize generative AI model execution based on predicted user activity times or network congestion patterns, thereby improving overall throughput and reducing peak load on computational resources.

Through these various embodiments and variations, the server, the terminal, and the user jointly participate in a technically integrated system that goes beyond mere automation of human tasks. The server implements specific data structures, algorithmic flows, and model-based computations that improve the speed, accuracy, and efficiency of content generation and delivery in a distributed computing environment, thus constituting an improvement in computer technology itself.

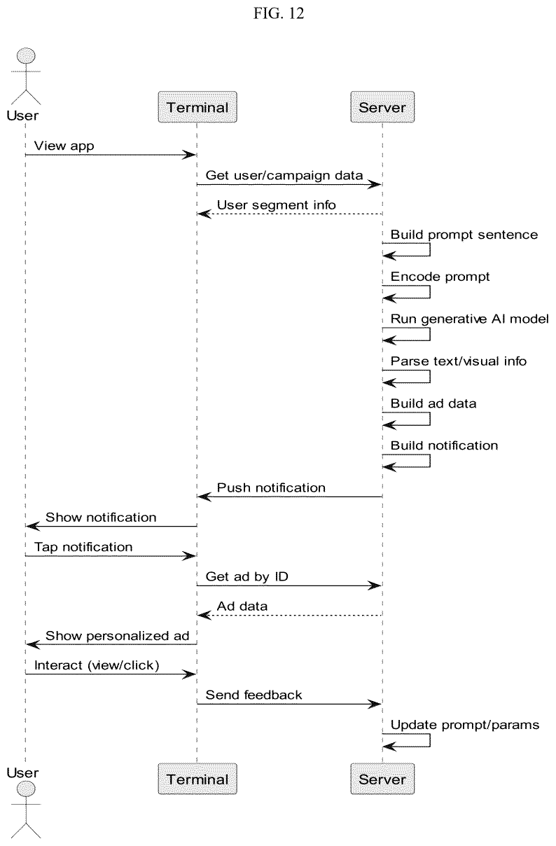

The following describes the processing flow using FIG. 12.

### Step 1:

The server acquires market information and target user information from a storage device or external interfaces.
Input: raw market information (for example, campaign definitions, product categories, seasonal data) and target user information (for example, targeting rules, user identifiers).

The server parses structured records, validates field formats, and normalizes values (for example, mapping internal codes to canonical category names). The server performs data aggregation, such as computing effective target segments from age ranges and interest tags, using arithmetic operations and lookup tables.
Output: normalized market information objects and target user segment definitions stored in a database and held in working memory for subsequent processing.

### Step 2:

The server obtains attribute information of users based on the target user information.
Input: target user segment definitions and a user database containing user profile records (for example, age, gender, interests, purchase history, device identifiers).

The server executes database queries that filter users according to the segment rules, performs join operations between user tables and campaign tables, and constructs in-memory user attribute structures. The server encodes each matched user with a unique identifier and associated attributes.
Output: a collection of user attribute information objects associated with one or more campaigns.

### Step 3:

The server performs emotion analysis to recognize an emotional state of each user.
Input: user attribute information, market information, and optional user interaction history (for example, past clicks, dwell time, feedback text).

The server extracts features such as recent interaction counts, sentiment scores of feedback text, and recency of purchases. The server converts these features into numeric vectors and inputs them to an emotion analysis model (for example, a trained neural network classifier).

The server computes forward passes through the model, calculates probabilities for predefined emotion classes, and selects the most probable class or a distribution summary.
Output: emotion analysis results comprising an emotional state label and associated confidence values for each user.

### Step 4:

The server constructs a prompt sentence for each user by combining market information, target user information, attribute information, and emotion analysis results.
Input: market information objects, user attribute information, and emotion analysis results.

The server selects a prompt template according to campaign type and desired content style.

The server then replaces placeholder tokens in the template with textual representations of age, gender, interests, recent purchases, campaign description, and emotion-related tone indicators. The server performs string concatenation and formatting, ensuring grammatical ordering and consistent style.
Output: a natural language prompt sentence for each user, ready to be encoded for a generative AI model.

### Step 5:

The server encodes each prompt sentence into an input format acceptable to the generative AI model.
Input: prompt sentences as text strings.

The server applies a tokenizer that splits each sentence into tokens and maps tokens to integer identifiers. The server generates attention masks, pads or truncates sequences to a fixed length, and arranges token identifiers into tensors. These operations involve array indexing, length comparison, and zero-padding calculations.
Output: encoded prompt data consisting of token id sequences, attention masks, and tensor representations stored in memory.

### Step 6:

The server executes the generative AI model to generate character information and visual information.
Input: encoded prompt data (token tensors) and generation condition parameters (for example, maximum length, temperature, top-k or top-p thresholds).

The server performs forward propagation through each layer of a neural network architecture (for example, embedding layer, self-attention layers, feed-forward layers, output layer). At each generation step, the server computes probability distributions over possible next tokens, applies the specified sampling or selection strategy, and appends the selected token to the output sequence. The server repeats these operations until a termination condition is satisfied.
Output: generated token sequences representing character information and visual information descriptions, which the server then decodes into text strings using the tokenizer's inverse mapping.

### Step 7:

The server parses the generated visual information into structured attributes.
Input: generated visual information text describing colors, layouts, and image concepts.

The server applies pattern matching and rule-based parsing to identify phrases that correspond to color attributes, layout attributes, and image concept attributes. The server may use regular expressions and keyword lookup tables to segment the text into labeled components. The server then constructs a structured data object (for example, a record with fields for main color, accent color, layout description, and image concept).
Output: structured visual information data containing color attributes, layout attributes, and image concept attributes.

### Step 8:

The server generates image-generation text information for an image generation model based on the structured visual information.
Input: structured visual information data (color attributes, layout attributes, image concept attributes).

The server selects an image-generation template and fills in fields using the extracted attributes, performing string concatenation and normalization of descriptive terms (for example, converting color attributes into standardized names). The server may remove layout-only phrases if the image generation model does not require them, focusing on semantic image concepts.
Output: image-generation text information as a concise textual description suitable for input to an image generation model.

### Step 9:

The server executes an image generation model to produce image data.
Input: image-generation text information.

The server converts the text information into an internal representation required by the image generation model (for example, token vectors or conditioning embeddings). The server iteratively runs the image generation model's network (for example, a diffusion process or generative adversarial network) to compute pixel-level or latent-space representations. The server then decodes these representations into image data in a standard format such as a bitmap or compressed image.
Output: image data representing a visual asset that corresponds to the generated concept.

### Step 10:

The server constructs advertisement information data by combining generated character information, structured visual information, and image data references.
Input: character information text, structured visual information data, and image data or image identifiers.

The server creates a structured advertisement record containing fields for title, body text, call-to-action text, color attributes, layout attributes, and an image reference. The server may derive a short title and call-to-action text by extracting or summarizing segments of the character information. The server stores this advertisement record in a database with associated identifiers.
Output: advertisement information data objects that represent complete personalized content units for users.

### Step 11:

The server converts the advertisement information data into notification data for a messaging infrastructure.
Input: advertisement information data and user device identifiers.

The server extracts key elements such as the title and a shortened body text and inserts them into a notification payload structure. The server attaches an advertisement identifier and user identifier to the payload. The server serializes the payload into a format required by the messaging infrastructure and schedules or sends it over the network interface.
Output: notification data transmitted to the messaging infrastructure and queued for delivery to terminals.

### Step 12:

The terminal receives notification data from the messaging infrastructure and presents a notification to the user.
Input: notification data delivered over a network.

The terminal's operating system invokes a notification handler, which parses the payload to extract the title, body text, and advertisement identifier. The terminal creates a visual notification on the display, using the extracted text and a default or configured style.
Output: a visible notification shown on the terminal's display, indicating that personalized content is available.

### Step 13:

The user interacts with the notification on the terminal.
Input: displayed notification on the terminal screen.

The user taps or selects the notification using the terminal's input interface. This action causes the terminal application to start or resume and to interpret the advertisement identifier embedded in the notification payload.
Output: a user interaction event that triggers the terminal to request full advertisement information data from the server.

### Step 14:

The terminal requests and receives advertisement information data from the server and renders personalized display content.
Input: advertisement identifier from the notification and a network connection to the server.

The terminal sends a request message to the server including the advertisement identifier. The server looks up the corresponding advertisement information data and returns it as a structured response. The terminal parses the response, downloads the referenced image data if necessary, and maps the structured fields (title, body, call-to-action, colors, layout) to user interface components. The terminal then arranges these components on the display according to the layout attributes and applies the color attributes to backgrounds, text, and buttons.
Output: personalized display content presented on the terminal's display, composed of text and images tailored to the user.

### Step 15:

The user views and operates on the personalized display content.
Input: personalized display content rendered on the terminal.

The user may scroll through the content, tap a call-to-action button, or close the content view. Each such operation is captured by the terminal as events that include timestamps and identifiers of the interacted elements.
Output: viewing information (such as time spent) and operation information (such as button taps) generated on the terminal.

### Step 16:

The terminal transmits viewing information and operation information to the server as feedback.
Input: event logs containing viewing information and operation information.

The terminal compacts the event data into a structured feedback message, possibly aggregating events over a short time window to reduce network overhead. The terminal then sends the feedback message to the server using a network protocol.
Output: feedback messages delivered to the server containing interaction data associated with specific advertisements and users.

### Step 17:

The server updates prompt construction logic and generation conditions of the generative AI model based on the feedback.
Input: feedback messages including viewing information and operation information, as well as stored advertisement information data and user data.

The server correlates feedback with particular prompt templates, emotion analysis results, and generation conditions that produced the original content. The server computes performance metrics such as click-through rates or average viewing duration for different prompt variants and model parameter settings. The server then modifies internal parameters, such as weights in a scoring function for template selection, sampling temperatures, or tone indicators embedded in prompt sentences. These modifications are stored in configuration data structures so that subsequent prompt sentences and model calls reflect the updated strategy.
Output: updated prompt construction rules and updated generation condition parameters, which influence future executions of the generative AI model and result in more effective and efficient personalized content generation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented marketing systems generally rely on static segmentation rules and manually authored content. Even when such systems collect attribute data and behavioral data of users, the systems often treat the data as simple filters and do not deeply exploit the structure of the data for automated content generation. As a result, the systems suffer from several technical limitations.

First, content generation pipelines are not tightly integrated with data preprocessing and model input management. Raw or inconsistently formatted user data is often passed directly or semi-manually into separate content authoring tools or external generative models. This leads to unstable input representations, inconsistent prompts, and non-reproducible outputs, thereby reducing the reliability and predictability of computer-generated content.

Second, existing systems typically do not provide a structured mechanism at the platform level for constructing machine-readable and human-readable prompt sentences that accurately reflect user attributes, behavioral patterns, delivery media constraints, and brand constraints in a unified format. Prompt construction is often handled in an ad hoc manner at the client application layer or by human operators, which introduces variability in how generative AI models are invoked and prevents the system from consistently leveraging the full richness of collected data.

Third, many systems treat generative AI models as opaque black boxes without systematic logging and association of prompts, model inputs, and model outputs with specific user segments. This lack of fine-grained historical linkage hinders technical optimization. The system cannot readily perform feedback-based improvements, automated A/B testing of prompts, or traceability for later analysis, thereby limiting the ability of the computing environment to iteratively improve content generation performance.

Fourth, when distributing generated content across multiple channels such as electronic mail and network-based social platforms, existing systems frequently perform manual or semi-manual adaptation to channel-specific constraints, such as character limits, pixel dimensions, layout rules, and prohibited expressions. This fragmentation results in duplicated processing logic, inconsistent enforcement of constraints, and increased latency in the content delivery pipeline, thereby reducing the overall efficiency of the computer system.

Accordingly, there is a need for a computer-implemented system that improves the technical process of generating, managing, and distributing personalized content. In particular, there is a need for a system that (i) automatically preprocesses user-related data into machine learning-ready feature quantities, (ii) programmatically constructs rich prompt sentences integrating user attributes, behavioral features, media constraints, and brand constraints, (iii) systematically interfaces with a generative AI model using those prompts and features, (iv) maintains structured historical associations of prompts, model inputs, and outputs for each target population, and (v) automatically adapts generated design data and text data to channel-specific constraints before distribution. By addressing these issues at the system and processor-configuration level, the invention aims to enhance the reliability, scalability, and efficiency of the underlying computer technology for automated personalized content generation and delivery.

The specific processing by the specific processing unit 290 of the data processing device 12 in Example 2 is realized by the following means.

The present invention provides a server comprising a processor and a storage device, the processor being configured to receive, from an information processing terminal, attribute information and behavioral information relating to a market and target users; store the attribute information and the behavioral information in the storage device and perform preprocessing including missing-value processing, noise removal, normalization, and encoding on the attribute information and the behavioral information so as to convert the attribute information and the behavioral information into feature quantities for machine learning; automatically construct a prompt sentence based on the preprocessed information, the prompt sentence including conditions indicating at least an age group, a gender, preferences, interests, purchasing tendencies, and needs of a target population, and including at least one of a delivery medium, an expression style, and brand constraints; provide the prompt sentence and the feature quantities as inputs to a generative artificial intelligence model and cause the generative artificial intelligence model to generate design data and text data corresponding to the target population; automatically allocate the generated design data and the generated text data to at least one of an electronic mail template, a network distribution advertisement template, and a printed matter template so as to convert the generated design data and the generated text data into advertisement content data; transmit the advertisement content data, via an electric communication network, to at least one of an electronic mail distribution apparatus and a social network advertisement distribution apparatus so as to cause personalized content to be delivered to end users; and record, in association with each target population, the prompt sentence, inputs to the generative artificial intelligence model, and outputs from the generative artificial intelligence model, and accumulate the recorded information as history information reusable in subsequent content generation processing. This enables the computer system to technically improve the end-to-end pipeline of personalized content generation by ensuring consistent machine-learning-ready feature preparation, systematic and reproducible prompt sentence construction, structured invocation and logging of generative artificial intelligence model interactions, and automatic channel-aware adaptation and distribution of generated advertisement content, thereby enhancing reliability, scalability, and processing efficiency in a manner rooted in the configuration and operation of the server itself.

The term “attribute information” refers to information that characterizes properties of a user or a user group, including, for example, an age group, a gender, preferences, interests, purchasing tendencies, and needs.

The term “behavioral information” refers to information that represents actions or patterns of actions of a user or a user group over time, including, for example, purchase history, browsing history, response history to advertisements, and interaction history with services.

The term “information processing terminal” refers to an electronic apparatus capable of data input and network communication, including, for example, a portable terminal, a stationary terminal, or any computing device with a user interface and communication functionality.

The term “storage device” refers to a hardware component or a combination of hardware components configured to store data in a non-transitory manner, including, for example, a semiconductor memory, a magnetic storage medium, or an optical storage medium.

The term “preprocessing” refers to a series of data processing operations performed on raw data before using the data as input to a machine learning model, including, for example, missing-value processing, noise removal, normalization, and encoding.

The term “missing-value processing” refers to a data processing operation that detects absent or undefined data elements in a dataset and handles the detected data elements by at least one of deletion, substitution, or estimation according to a predefined rule.

The term “noise removal” refers to a data processing operation that detects and reduces or eliminates data elements that are erroneous, inconsistent, or irrelevant with respect to intended analysis or model training.

The term “normalization” refers to a data processing operation that converts numerical data into a standardized range or distribution, including, for example, scaling to a predetermined interval or standardizing to have a predetermined statistical property.

The term “encoding” refers to a data processing operation that converts categorical or symbolic data into a numerical representation suitable for processing by a machine learning algorithm, including, for example, one-hot encoding, index encoding, or embedding.

The term “feature quantities for machine learning” refers to numerical values or structured numerical representations derived from raw data that are used as input variables to a machine learning model.

The term “target population” refers to a subset of users or potential users defined by one or more conditions including at least an age group, a gender, preferences, interests, purchasing tendencies, and needs.

The term “prompt sentence” refers to a text sequence that describes one or more conditions, constraints, or instructions and that is provided as input to a generative artificial intelligence model in order to control or guide content to be generated.

The term “delivery medium” refers to a communication channel or format used to present content to an end user, including, for example, electronic mail, network-based advertisement, printed material, or a social networking service.

The term “expression style” refers to a set of conditions relating to the manner in which content is expressed, including, for example, tone, formality, design style, color scheme, and layout preference.

The term “brand constraints” refers to conditions representing rules or limitations associated with a brand, including, for example, permitted or prohibited expressions, stylistic guidelines, logo usage rules, and color usage rules.

The term “generative artificial intelligence model” refers to a machine learning model configured to generate new data, such as text data or image data, in response to an input including at least a prompt sentence and feature quantities.

The term “design data” refers to data representing a visual composition, including, for example, layout information, color information, graphic element information, and image information suitable for rendering a visual advertisement or a printed material.

The term “text data” refers to data representing a sequence of characters or symbols intended to be presented as natural language expressions, including, for example, headlines, body text, and call-to-action messages.

The term “electronic mail template” refers to a structured layout definition for electronic mail content, including specified regions for inserting design data, text data, and metadata such as a subject line and sender information.

The term “network distribution advertisement template” refers to a structured layout definition for advertisement content to be distributed over a communication network, including specified regions for inserting design data, text data, and configuration parameters for online advertisement platforms.

The term “printed matter template” refers to a structured layout definition for content to be output on a physical recording medium, including specified regions for inserting design data, text data, and printing parameters.

The term “advertisement content data” refers to data generated by allocating design data and text data to at least one template so that the data can be directly used for distribution or output as an advertisement.

The term “electric communication network” refers to an infrastructure configured to transmit information by using electrical or electromagnetic signals, including, for example, a local area network, a wide area network, or a public communication network.

The term “electronic mail distribution apparatus” refers to an apparatus or service configured to send electronic mail messages to one or more destination addresses based on input advertisement content data.

The term “social network advertisement distribution apparatus” refers to an apparatus or service configured to distribute advertisement content through a social networking service based on input advertisement content data and targeting conditions.

The term “end user” refers to an individual or entity that ultimately receives or views the personalized content generated and distributed by the system.

The term “history information” refers to data that associates, for at least one target population, prompt sentences, inputs to a generative artificial intelligence model, and outputs from the generative artificial intelligence model, and that is stored for reuse in subsequent processing.

The term “image acquisition apparatus” refers to a device configured to capture static images and output corresponding image information, including, for example, a digital camera or an image sensor-equipped terminal.

The term “video acquisition apparatus” refers to a device configured to capture moving images and output corresponding video information, including, for example, a video camera or a video sensor-equipped terminal.

The term “image analysis processing” refers to a computation process that analyzes image information or video information to extract feature quantities indicating attributes of at least one of humans, scenes, or products.

The term “human attributes” refers to attributes relating to a person present in image information or video information, including, for example, estimated age, estimated gender, pose, clothing type, or facial expression.

The term “scene attributes” refers to attributes relating to a background or environment depicted in image information or video information, including, for example, location type, time-of-day condition, or indoor/outdoor classification.

The term “product attributes” refers to attributes relating to a product depicted in image information or video information, including, for example, product category, shape, size, color, or arrangement.

The term “distribution channel” refers to a specific route or platform through which advertisement content data is delivered to end users, including, for example, an electronic mail service or a social networking service.

The term “character-number limitation” refers to a constraint condition specifying a maximum or minimum number of characters permitted for text data in a given distribution channel.

The term “pixel-number limitation” refers to a constraint condition specifying allowable dimensions or resolution for image data used in a given distribution channel.

The term “image layout limitation” refers to a constraint condition specifying permissible arrangements, aspect ratios, or positioning of images within advertisement content for a given distribution channel.

The term “prohibited-expression condition” refers to a constraint condition specifying words, phrases, or categories of expressions that are not allowed to appear in text data for a given brand policy, legal requirement, or platform rule.

Server, terminal, and user cooperate to implement embodiments of the invention as follows.

In one embodiment, server includes at least one hardware processor, a main memory, a non-transitory storage device, and a network interface. Server is realized, for example, by a general-purpose computer system or a virtual machine executing an operating system such as a general-purpose server operating system. Server executes application software including a web application module, a data preprocessing module, a generative AI interface module, a template allocation module, and a distribution control module. Server further includes a database management system, such as a relational database system or a key-value store, stored on the non-transitory storage device.

Terminal includes a user interface device such as a display and an input device, and a communication interface. Terminal is realized, for example, by a portable information terminal or a conventional personal computer executing a web browser or a native application. User operates terminal to input information and to confirm content generated by server.

User operates terminal to access a web-based console or a native application for campaign configuration. Terminal displays graphical user interface elements, such as text fields, drop-down lists, and check boxes, for entering attribute information and behavioral information regarding a market and target users. Attribute information includes, for example, an age group, a gender, preferences, and interests. Behavioral information includes, for example, purchase history and reaction history to previous content. Terminal validates basic format (for example, numeric ranges and required fields) and transmits the validated information as structured data via a secure communication protocol to server.

Server receives the attribute information and the behavioral information via the network interface and stores them in a database controlled by the database management system. Server represents each target population as a record in a table or collection including fields such as segment identifier, age range, gender category, interest tags, purchase frequency metrics, and last interaction date. By defining such structured records, server ensures that subsequent processing can access user segment information with constant-time field lookups, improving data management efficiency.

Server executes the data preprocessing module to transform raw attribute information and behavioral information into feature quantities suitable for machine learning. In one embodiment, server loads stored records into an in-memory data structure, such as a matrix or a tensor, and performs missing-value processing by detecting null entries and applying at least one of deletion and imputation based on statistical aggregation. Server removes noise by detecting outlier values using, for example, a distance-based or quantile-based threshold and by filtering records with inconsistent category codes.

Server performs normalization by scaling numerical attributes (for example, purchase frequency, recency scores, and age values) into a standardized range (for example, [0, 1]) or a standardized distribution (for example, zero mean and unit variance). Server performs encoding by converting categorical attributes (for example, gender, main interest category, or preferred style) into numerical representations such as one-hot vectors or learned embeddings. In one embodiment, server maintains an embedding table in memory, where each distinct categorical value is mapped to a low-dimensional dense vector; server updates or initializes this table based on previously observed values. This specific transformation process reduces dimensionality and sparsity compared to naive encoding, leading to improved convergence and inference speed of the downstream neural network and thereby improving computer processing efficiency.

Server assembles the feature quantities into a unified feature vector associated with each target population. In one example, server concatenates demographic features, behavioral features, and content preference features into a fixed-length vector. Server stores this vector in the database or in a feature store with an index keyed by segment identifier. This consistent, machine-learning-ready representation is a technical improvement over ad hoc use of raw data because it allows the generative AI model interface module to access structured features without repeated re-parsing or re-normalization, reducing redundant computation and memory access.

Server automatically constructs a prompt sentence using the preprocessed information. In one embodiment, server uses a template mechanism implemented in the application software. Server selects a base template based on the intended delivery medium (for example, email or a social networking advertisement) and brand profile, and then inserts values derived from feature quantities into specific placeholders. Server generates prompt sentences such as: “Generate an advertising design and promotional copy for women in their twenties who love fashion and frequently purchase clothing online. Use a trendy, minimalist style and emphasize the latest seasonal trends.” or “Please generate an advertising design and catch copy in a minimalist style that incorporates the latest trends, targeted at women in their 20s who love fashion and frequently purchase clothing online.”

In this manner, server composes prompt sentences that encode, in text form, the structured information of the target population together with channel constraints and brand constraints. Because the prompt sentence is derived systematically from feature quantities with deterministic rules, server minimizes variability and inconsistency that would otherwise arise from manual prompt creation and thereby improves the reproducibility and stability of AI-based content generation.

Server interfaces with a generative AI model using the generative AI interface module. In one embodiment, the generative AI model is a neural network implemented on a computing platform that may be internal to server or external via an application programming interface. Server transmits the prompt sentence and the feature quantities as model input. In one concrete embodiment, the generative AI model includes a text generation component realized by a transformer-based architecture having a plurality of self-attention layers, feed-forward layers, and layer normalization components. The model parameters include weight matrices and bias vectors, which are stored in floating-point format.

Server provides the prompt sentence as a sequence of tokens and, in one variation, provides the feature quantities as an auxiliary input vector concatenated to or attended by the token embeddings. The neural network computes successive hidden states according to attention weights and activation functions such as rectified linear units or similar functions, and outputs probability distributions over vocabulary tokens at each position. The model is trained in advance using a loss function such as cross-entropy, computed between predicted token distributions and reference sequences, and model parameters are updated using a gradient-based optimization algorithm such as stochastic gradient descent or its variants. During this training, data augmentation strategies and regularization techniques, such as dropout or weight decay, may be applied. As a result, the model learns statistical relationships between prompt patterns, feature quantities, and desired outputs.

In an image generation embodiment, server provides the prompt sentence and potentially a compressed representation of the feature quantities to an image generative model. The image generative model may include, for example, an encoder-decoder architecture with latent variables or a diffusion-based network. The model interprets the prompt sentence by encoding it into semantic vectors and conditions image generation on these vectors, thereby producing image data representing a design layout. Here, server uses a specific mapping from feature quantities to conditioning vectors or class labels so that the generative process is directly influenced by the structured segment information. This design allows server to enforce a more deterministic relationship between input attributes and output image content, improving precision and reducing variance in generated results relative to ad hoc, text-only prompting.

Server receives generated text data and design data from the generative AI model. Server then executes the template allocation module to integrate the generated content with pre-defined templates. For email, server prepares an electronic mail template including placeholder regions for a subject line, a header image, a main message area, and a call-to-action button. Server inserts the generated headline into the subject line and header area, and inserts the generated body text and call-to-action text into the main area and button label. For a social networking advertisement, server prepares a network distribution advertisement template including image layout regions and caption regions, and server inserts the generated design data into the image region and the generated concise text into the caption field.

Server applies channel-specific constraint enforcement by executing the distribution control module. For example, server measures the number of characters in each text field and, if a maximum non-zero threshold defined by the distribution channel is exceeded, server modifies or truncates text based on predefined rules or, in some embodiments, generates a secondary prompt sentence instructing the generative AI model to produce a shorter variant. Server evaluates image dimensions and pixel counts and, as necessary, resizes or crops images using an image processing library. By permanent incorporation of these rules into server logic, the system reduces the risk of transport-layer or platform-layer rejections and obviates repeated manual corrections, thereby reducing communication load and improving throughput.

Server records, in the database, the prompt sentence, the feature quantities provided to the generative AI model, and the generated outputs, together with identifiers specifying the target population, the campaign, and the distribution channel. Server thereby builds history information that can be re-used in later invocations. For example, when user defines a similar target population in a subsequent campaign, server can retrieve previous prompt sentences and outputs and either reuse them or generate new ones using a modified template that references prior successful patterns. This historical linkage constitutes a structured data store that supports technical optimization procedures such as automatic selection of high-performing prompt formats and automated A/B testing. Because server manages this history at scale with indexed queries and incremental updates, the system improves data management efficiency relative to systems that only log unstructured text or do not log prompts at all.

In one concrete example, user specifies through terminal that the target population is “women aged 20-29, interested in sustainable fashion, frequently purchasing apparel online.”

Terminal sends this information to server. Server converts “sustainable fashion” into an internal interest code and maps purchase frequency into a normalized numerical value. Server constructs a prompt sentence such as:

“Generate three variations of email marketing copy for women in their twenties who are interested in sustainable fashion and frequently buy clothes online. Emphasize eco-friendly materials and limited-time online offers, and use a friendly and aspirational tone.”

Server passes the prompt sentence and associated feature vector to the generative AI model. The model outputs three candidate email bodies. Server enforces channel constraints by verifying that each body satisfies the character limitation and does not contain prohibited phrases according to brand constraints. Server allocates the candidate contents into the email template, stores the association in history information, and schedules distribution via an electronic mail distribution apparatus.

From a technical perspective, the described configuration produces several effects beyond mere automation of human creative work. Because server performs a standardized sequence of data normalization and encoding operations before feature quantities reach the generative AI model, the model receives inputs of consistent scale and structure. This directly reduces the magnitude of numerical instabilities in neural computation, decreases the variance of gradients during training, and improves convergence behavior and inference stability. Consequently, computational resources such as processor cycles and main memory usage are used more efficiently.

Furthermore, by programmatically generating prompt sentences tied to structured feature vectors instead of manually authored prompts, server reduces entropy in the input space seen by the generative AI model. This constraint makes it possible to cache and reuse internal representations for frequent prompt patterns and thereby reduce inference latency on repeated queries. In addition, server can apply algorithmic selection of prompt templates based on stored performance metrics in the history information, which allows server to systematically improve output quality and resource utilization over time.

In another embodiment, server deploys separate generative AI models specialized for different channels, such as an email-copy model and a social-media-caption model, and selects the model based on delivery medium indicators present in the prompt sentence and feature quantities. This modular architecture enables independent scaling of model resources and tailored training for each channel, which leads to improved precision for each output type while avoiding unnecessary invocation of large general-purpose models.

In another variation, server implements a hybrid rule-based and neural approach in the generative AI interface module. Server first applies deterministic rules to identify required elements (such as discount percentage, product category, or time window) from feature quantities and inserts those values into a structured prompt skeleton. The generative AI model then handles only stylistic variation and natural language fluency. This division of labor between deterministic logic and neural generation prevents omission of critical factual information and reduces the error rate of generated content. Thus, the system achieves a technical effect of improved factual correctness without increasing human intervention. Terminal, in these embodiments, is not merely a passive viewer but cooperates in the technical process by formatting and compressing input data before transmission and by validating and displaying structured status information from server. For example, terminal can request from server, and display, a list of previously generated prompts and associated performance metrics for a given target population. This visualization is based on indexed queries on history information, and enables user to select particular patterns for reuse. Because server prepares and serves this information in compressed or summarized form, network traffic is reduced and terminal processing requirements remain low.

Although specific hardware and software examples such as a server operating system, relational database management system, and neural network architectures have been described for explanatory purposes, these are illustrative and not limiting. Server may be implemented as a cluster of nodes; the generative AI model may execute on dedicated acceleration hardware; and data preprocessing, prompt construction, and template allocation may be distributed across multiple physical machines, as long as the functional relationships and data flows described above are maintained. In all such variations, server, by virtue of its specific configuration and cooperation with terminal and user, improves the internal operation of the computer system for personalized content generation, including processing speed, data consistency, memory efficiency, and reliability of interactions with generative AI models.

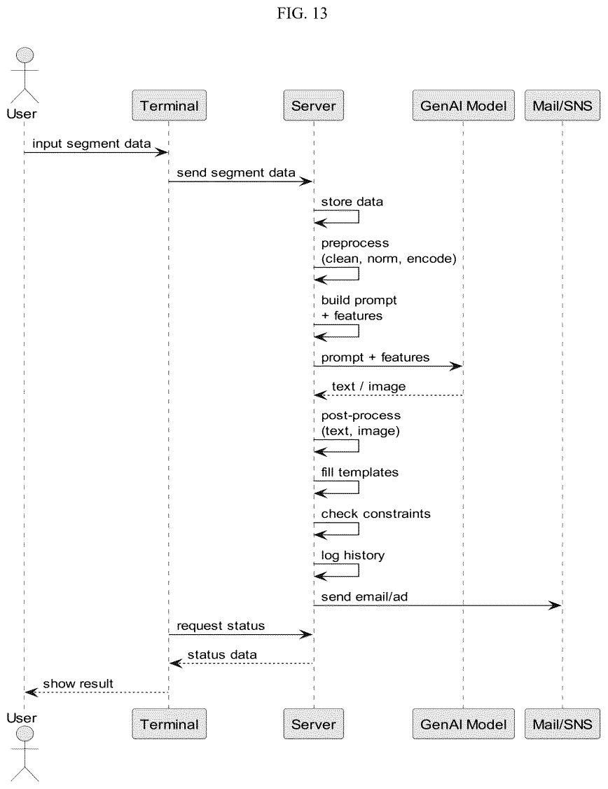

The following describes the processing flow using FIG. 13.

### Step 1:

User operates terminal to input market and target-user information.

User views an input screen on terminal that includes fields for age group, gender, interests, preferences, and purchase history.

The input of this step is raw user-entered data items, such as text strings and numerical values.

The output of this step is a structured data object (for example, a set of key-value pairs) temporarily stored in terminal memory.

Terminal validates formats (for example, checks that an age range is numeric and that required fields are not empty), converts the fields into a structured representation, and holds the data ready for transmission.

### Step 2:

Terminal transmits the structured attribute information and behavioral information to server.

The input of this step is the structured data object generated in Step 1.

The output of this step is a network request carrying the structured data over a communication channel to server.

Terminal encapsulates the structured data into a request message, attaches metadata such as a timestamp and a terminal identifier, and sends the message to a predefined endpoint on server via a secure communication protocol.

### Step 3:

Server receives the request and stores the attribute information and behavioral information in a storage device.

The input of this step is the request message containing structured attribute and behavioral information.

The output of this step is one or more persistent records inserted into database tables or collections.

Server parses the received message, maps each field (for example, age group, gender, interest tags, purchase frequency) to corresponding database columns, and executes write operations through a database management system so that the information becomes persistently stored and indexed.

### Step 4:

Server loads stored segment records and constructs an internal data structure for preprocessing.

The input of this step is one or more database records associated with at least one target population.

The output of this step is an in-memory representation, such as a matrix or list of records, ready for data preprocessing.

Server issues a query to select segments requiring content generation, retrieves matching records, and converts the result set into an internal data structure with clearly defined fields for numerical and categorical attributes.

### Step 5:

Server performs missing-value processing on the loaded data.

The input of this step is the in-memory representation containing possibly incomplete attribute and behavioral information.

The output of this step is an updated data structure in which missing entries have been handled according to predetermined rules.

Server scans each field for null or undefined values, counts their occurrences, and applies a rule such as deletion of incomplete records or imputation using mean, median, or mode values; server then replaces or removes entries accordingly, thereby producing a dataset without unhandled missing values.

### Step 6:

Server performs noise removal on the cleaned data.

The input of this step is the dataset after missing-value processing.

The output of this step is a dataset with reduced noise, in which outlier and inconsistent records have been filtered or corrected.

Server computes statistical measures such as minimum, maximum, percentile values, or z-scores for numerical features (for example, purchase frequency, recency), detects outliers based on thresholds, and either removes those records or clips their values; server also checks categorical fields against a predefined list of valid categories and corrects or discards invalid entries.

### Step 7:

Server performs normalization of numerical features.

The input of this step is the denoised dataset containing numerical attributes such as age values, purchase counts, and recency scores.

The output of this step is a dataset whose numerical attributes are scaled or standardized into a predefined numeric range or distribution.

Server computes scaling parameters (for example, minima, maxima, means, and standard deviations) across the dataset and applies mathematical transformations to each numerical field, such as min-max scaling to a [0, 1] interval or standardization to zero mean and unit variance, and replaces original values with normalized ones.

### Step 8:

Server performs encoding of categorical features into numerical representations.

The input of this step is the dataset containing categorical attributes such as gender, interest categories, and preferred styles.

The output of this step is a set of numerical vectors representing each record as machine-learning-ready feature quantities.

Server assigns integer indices or one-hot vectors to each category or, in another embodiment, retrieves dense embedding vectors from an embedding table; server then concatenates these vectors with normalized numerical features to construct a fixed-length feature vector for each target population and stores these feature vectors in memory or in a feature store.

### Step 9:

Server assembles feature vectors and associates them with segment identifiers.

The input of this step is the set of encoded numerical representations and the original identifiers for each target population.

The output of this step is a mapping from each segment identifier to a corresponding feature vector.

Server constructs a data structure, such as a dictionary or table, that binds each segment identifier to one feature vector, and stores this mapping in the storage device for subsequent retrieval by the generative AI interface module.

### Step 10:

Server generates a prompt sentence for each target population using the preprocessed information.

The input of this step is the mapping from segment identifiers to feature vectors and, optionally, additional configuration such as delivery medium and brand rules.

The output of this step is at least one prompt sentence in natural language for each segment. Server selects a template based on delivery medium (for example, email or social advertisement) and brand constraints (for example, tone and prohibited expressions), inserts segment attributes such as age range, gender, interests, and purchase behavior into template placeholders, and forms a text string such as “Generate an advertising design and promotional copy for women in their twenties who love fashion and frequently purchase clothing online.

Use a trendy, minimalist style and emphasize the latest seasonal trends.”

### Step 11:

Server prepares model input combining the prompt sentence and the feature vector.

The input of this step is the prompt sentence text and the corresponding feature vector for a target population.

The output of this step is a model input structure that can be submitted to a generative AI model.

Server converts the prompt sentence into tokens or embeddings, reformats the feature vector into a compatible shape, and packages them into a request payload that includes both textual and numerical components, along with control parameters such as maximum output length and temperature.

### Step 12:

Server transmits the model input to a generative AI model and requests generation of text data.

The input of this step is the model input structure containing the prompt sentence and feature vector.

The output of this step is raw generated text data representing candidate advertising copy, such as headlines and body text.

Server sends the payload to a generative AI model endpoint or invokes a local generative model, passes the tokenized prompt and feature vector through the model's network layers, and receives an output sequence of tokens, which server converts back into a text string.

### Step 13:

Server optionally transmits the model input to a generative AI model for image generation and requests design data.

The input of this step is the prompt sentence and optionally a compressed representation of the feature vector suitable for conditioning.

The output of this step is generated image data representing a design layout, such as a banner or advertisement image.

Server sends the prompt sentence and conditioning information to an image-generating model, receives a tensor representing pixel values or an encoded image format, and converts this tensor into a file format such as a bitmap or compressed image.

### Step 14:

Server post-processes the generated text data.

The input of this step is raw text output from the generative AI model.

The output of this step is cleaned and constrained text data ready for template allocation.

Server scans the text to remove extraneous content, enforces limits on character count by truncating or requesting shorter variants, checks for prohibited expressions using a rule set, and applies formatting rules such as capitalization of headlines, thereby producing multiple text fields such as headline, body text, and call-to-action phrase.

### Step 15:

Server post-processes the generated design data.

The input of this step is raw image data output from the generative AI model.

The output of this step is one or more images conforming to size, aspect ratio, and quality requirements.

Server decodes the image data if necessary, resizes or crops the image to required pixel dimensions, adjusts resolution, and compresses the image using appropriate encoding parameters, and saves the processed image in storage with an identifier.

### Step 16:

Server allocates the processed text data and design data into an electronic mail template.

The input of this step is the processed text data, processed image data, and a predefined email template layout.

The output of this step is complete email content data suitable for an electronic mail distribution apparatus.

Server fills placeholder regions in the template with the generated headline, body text, call-to-action text, and image, constructs an email body in a markup format including layout information, and stores the resulting email content with a reference to the corresponding target population.

### Step 17:

Server allocates the processed text data and design data into a network distribution advertisement template.

The input of this step is the processed text data, processed image data, and a predefined advertisement layout for a social networking platform or similar medium.

The output of this step is advertisement content data conforming to the target platform's requirements.

Server inserts the image into an image region of the advertisement template, places short text such as a caption or title into a text region, and stores a configuration object containing the advertisement content and metadata such as creative identifier and target segment.

### Step 18:

Server enforces channel-specific constraints on the advertisement content data.

The input of this step is provisional advertisement content data for one or more channels.

The output of this step is validated advertisement content data that satisfies character-number limitations, pixel-number limitations, image layout limitations, and prohibited-expression conditions.

Server examines each field in the advertisement content data, compares lengths and dimensions against channel-specific parameters, modifies or truncates fields exceeding limits, and, if necessary, regenerates certain fields using new prompt sentences; server then flags and stores only those versions that satisfy all applicable constraints.

### Step 19:

Server records history information linking prompts, model inputs, and outputs to target populations.

The input of this step is the prompt sentence, feature vector, generated text data, generated design data, and identifiers of target populations and channels.

The output of this step is one or more history records stored in the storage device.

Server creates a record including fields for segment identifier, timestamp, prompt sentence, model input parameters, generated outputs, and performance statistics placeholders, inserts the record into a history table, and indexes it for subsequent retrieval and analysis.

### Step 20:

Server transmits the validated advertisement content data to an electronic mail distribution apparatus.

The input of this step is email content data associated with a target population and, optionally, a list of recipient electronic mail addresses.

The output of this step is a set of messages queued or accepted by the electronic mail distribution apparatus.

Server formats requests according to the distribution apparatus protocol, attaches email content data and addressing information, sends the requests via the communication network, and receives responses indicating acceptance or error status, which server stores as part of distribution logs.

### Step 21:

Server transmits the validated advertisement content data to a social network advertisement distribution apparatus.

The input of this step is advertisement content data and targeting parameters corresponding to the target population.

The output of this step is a set of registered advertisements on the social network advertisement distribution apparatus.

Server connects to the apparatus through an application programming interface, uploads the processed image and text, configures targeting attributes such as age and interests derived from the feature vector, and registers the advertisement for delivery by the platform, storing identifiers returned by the apparatus.

### Step 22:

Terminal retrieves status information and displays results to user.

The input of this step is a request from user to view campaign status and corresponding response data from server containing summary information and logs.

The output of this step is a visual display showing generated prompts, content variants, and distribution states.

Terminal sends a query to server, receives structured status data including segment identifiers, prompt sentences, performance metrics, and delivery counts, renders this data as tables or charts on the display, and allows user to inspect which target populations received which generated content.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content delivery systems that use machine learning or rule-based engines to personalize advertisements or other digital content typically treat user attributes, market information, and emotional state as separate and loosely coupled data streams. In many implementations, demographic data and behavioral logs are processed in back-end systems to segment users, while any available emotion recognition is performed independently at the user interface layer or not used at all. As a result, the system often fails to generate content that is aligned with both the current emotional state of the user and the user's long-term attributes, leading to low engagement and inefficient use of computational and network resources.

Furthermore, existing systems usually provide a static integration with generative models. A generative model is given a simple, pre-defined input, and the generated content is delivered to a terminal without any closed-loop feedback based on user reactions. Such architectures do not systematically encode the combination of user attributes, market conditions, and emotion information into a structured prompt sentence, and therefore cannot fully exploit the expressive power of generative models. This limits the capability of the computer system to dynamically adapt content generation strategies and often requires extensive manual tuning of rules or templates, which is computationally and operationally inefficient.

In addition, many content generation pipelines are architected as monolithic black boxes. Once deployed, these systems cannot effectively adjust their internal prompt construction or content generation conditions based on granular reaction information such as viewing behavior or manipulation behavior collected from user terminals. The absence of a built-in learning loop at the system level prevents continuous improvement of the prompt design and model invocation strategy, and therefore the underlying computer system cannot improve its performance characteristics, such as relevance of generated content, latency of content selection, or resource utilization on both server and client devices.

From the standpoint of computer technology, there is a need for an improved system architecture and processing method that: (i) integrates acquisition of user-related information, market-related information, and multi-modal emotion analysis into a unified feature representation; (ii) converts this representation into a structured prompt sentence for a generative artificial intelligence model; (iii) dynamically selects between internal and external generative models; (iv) performs post-processing of generated content based on control rules and emotion; and (v) collects and reuses reaction information to update future prompt and content generation conditions. Such improvements should enhance the computer's ability to process heterogeneous data streams, reduce manual configuration, and increase the efficiency and effectiveness of personalized content generation and distribution.

The specific processing by the specific processing unit 290 of the data processing device 12 in Application Example 2 is realized by the following means.

The present invention provides a server comprising a processor configured to acquire user-related information and market-related information from storage resources and communication interfaces, to extract attribute information from the user-related information, and to perform emotion analysis that identifies an emotional state of a user based on observation information obtained from an imaging device, an audio acquisition device, and a character information acquisition device, to generate feature information including a plurality of elements comprising at least an age group, a gender, an interest, a purchase history, the emotional state, a content type, and an expression style, on the basis of the attribute information and the emotional state, and to convert the feature information into a natural language expression to construct a prompt sentence serving as input to a generative artificial intelligence model, to input the prompt sentence into the generative artificial intelligence model and cause the generative artificial intelligence model to generate content data including visual elements and character string information corresponding to the feature information and the emotional state, to perform post-processing based on the emotional state and predetermined control rules to correct at least one of a color tone, a layout, a wording tone, and a message content in the content data to construct personalized content for an end user, to distribute the personalized content to an information processing terminal via a communication path or to distribute the personalized content via an electronic mail distribution infrastructure or an information providing platform, and to collect reaction information to the personalized content based on viewing operation information and manipulation operation information acquired from the information processing terminal, record the reaction information in association with the prompt sentence and the emotional state, and execute a learning process that updates at least one of generation conditions of the prompt sentence and generation conditions of the content data for a subsequent generation process. This enables the computer system to internally integrate multi-modal user and market data into a structured prompt representation, to control invocation and post-processing of generative artificial intelligence models in a closed-loop manner, and to adapt the prompt construction and content generation behavior based on measured user reactions, thereby improving the technical performance of personalized content generation and delivery in terms of relevance, adaptability, and computational efficiency.

The term “user-related information” refers to information associated with an individual user, including but not limited to demographic information, behavioral information, preference information, and historical interaction information collected from one or more information processing terminals or storage resources.

The term “market-related information” refers to information describing a commercial or service environment in which content is provided, including but not limited to segment information, campaign information, product category information, and trend information obtained from databases, external systems, or analytic services.

The term “attribute information” refers to structured information representing characteristics of a user, including but not limited to an age group, a gender, an interest category, a purchase history summary, and other profile-related descriptors derived from user-related information.

The term “emotion analysis” refers to processing that estimates or classifies an emotional state of a user based on observation information, including but not limited to image data, audio data, and text data, by applying a computational model or rule set.

The term “emotional state” refers to a classification or parameterization of a user's affective condition at a given time, including but not limited to categories such as joy, sadness, anger, surprise, fear, neutrality, or corresponding continuous scores.

The term “observation information” refers to data acquired from one or more sensing devices observing a user, including but not limited to image signals from an imaging device, audio signals from an audio acquisition device, and text signals from a character information acquisition device.

The term “imaging device” refers to a hardware device configured to capture image data or video data of a user or an environment, including but not limited to a digital camera, a web camera, or an image sensor incorporated in an information processing terminal.

The term “audio acquisition device” refers to a hardware device configured to capture audio data generated by a user or an environment, including but not limited to a microphone, an array microphone, or an audio input component of an information processing terminal.

The term “character information acquisition device” refers to a hardware device or software interface configured to obtain textual information from a user, including but not limited to a keyboard, a touch panel, a character input interface, or a communication interface receiving text messages.

The term “feature information” refers to structured data generated by transforming and integrating attribute information and emotional state information into a multi-dimensional representation suitable for processing by a generative artificial intelligence model or a prompt construction module.

The term “age group” refers to a categorical representation of a user's age, expressed as a range or class, including but not limited to teens, twenties, thirties, or other predefined age brackets.

The term “interest” refers to a category or descriptor indicating a user's preference or affinity toward particular topics, goods, services, or activities, such as fashion, travel, sports, or technology.

The term “purchase history” refers to information summarizing or listing past transactions associated with a user, including but not limited to purchased item categories, purchase frequency, purchase amounts, and temporal patterns.

The term “content type” refers to a classification of a content item to be generated or delivered, including but not limited to an advertisement, a recommendation item, a notification, an informational message, or a promotional message.

The term “expression style” refers to a set of parameters or descriptors that characterize a presentation manner of content, including but not limited to visual style, linguistic tone, formality level, and layout pattern.

The term “natural language expression” refers to a representation in a human language, such as an ordered sequence of words or symbols, that describes feature information in a form suitable for inputting to or processing by a generative artificial intelligence model.

The term “prompt sentence” refers to a natural language expression or sequence of expressions that instructs a generative artificial intelligence model regarding a desired output, wherein the prompt sentence encodes at least part of the feature information and one or more generation constraints.

The term “generative artificial intelligence model” refers to a computational model trained to generate data such as text or images based on input information, including but not limited to probabilistic neural network models that produce content conditioned on prompt sentences or feature vectors.

The term “content data” refers to digital data generated by a generative artificial intelligence model in response to a prompt sentence, including but not limited to visual elements, character string information, and associated metadata defining a content item for delivery to an end user.

The term “visual elements” refers to graphical components included in content data, including but not limited to images, icons, color schemes, backgrounds, and layout structures.

The term “character string information” refers to textual components included in content data, including but not limited to headlines, body texts, captions, and call-to-action messages.

The term “post-processing” refers to processing applied to content data after initial generation by a generative artificial intelligence model, including but not limited to modification, filtering, correction, or augmentation of visual elements and character string information according to predetermined rules or conditions.

The term “color tone” refers to characteristics of color used in visual elements, including but not limited to hue, saturation, brightness, and combinations thereof that define a perceived visual mood.

The term “layout” refers to an arrangement pattern of visual elements and character string information within a display region or medium, including but not limited to positions, sizes, alignment relationships, and ordering of elements.

The term “wording tone” refers to stylistic characteristics of textual expressions, including but not limited to formality, positivity, empathy, urgency, and friendliness.

The term “message content” refers to semantic information conveyed by character string information, including but not limited to offers, explanations, instructions, or promotional statements directed to an end user.

The term “personalized content” refers to content data that has been adapted or generated in accordance with at least the attribute information and the emotional state of a specific user, such that the content is tailored to that user.

The term “end user” refers to a human recipient who views, reads, or otherwise consumes the personalized content through an information processing terminal or another output device.

The term “information processing terminal” refers to a computing device configured to communicate with the server, to present personalized content, and to acquire operation information, including but not limited to a smartphone, a tablet device, a personal computer, or a smart display.

The term “communication path” refers to a logical or physical channel for data transfer between the server and an information processing terminal or another system, including but not limited to wired networks, wireless networks, and packet-switched communication systems.

The term “electronic mail distribution infrastructure” refers to a computing environment or service that transmits electronic mail messages to one or more recipient addresses, including but not limited to mail servers, mail transfer agents, and associated communication protocols.

The term “information providing platform” refers to a computing environment or service that delivers content to users via a network, including but not limited to social networking platforms, advertising networks, and content delivery platforms.

The term “reaction information” refers to information representing a response of an end user to personalized content, including but not limited to viewing behavior, manipulation behavior, click events, dwell times, and dismissal actions.

The term “viewing operation information” refers to information indicating that personalized content has been displayed or observed on an information processing terminal, including but not limited to screen exposure duration, scroll position, and visibility status.

The term “manipulation operation information” refers to information indicating direct user operations performed on or around personalized content, including but not limited to touch inputs, clicks, selections, or input gestures.

The term “learning process” refers to processing that updates one or more parameters, rules, or configuration data associated with prompt construction or content generation, based at least on reaction information, so as to modify subsequent behavior of the system.

The term “generation conditions of the prompt sentence” refers to parameters, templates, rules, or weighting factors used to construct a prompt sentence from feature information and other inputs, including but not limited to selection conditions for template information and mapping rules from attributes to textual expressions.

The term “generation conditions of the content data” refers to parameters or constraints governing how a generative artificial intelligence model produces content data, including but not limited to sampling parameters, style constraints, content type specifications, and post-processing rules.

The term “template information” refers to a predefined data structure or pattern for constructing a prompt sentence, including placeholders for attribute information, emotional state, and style information.

The term “style information” refers to parameters or descriptors that specify a desired style for generated content in terms of visual design or linguistic expression, including but not limited to brightness level, color preference, tone of voice, and layout preference.

The term “internal computational resources” refers to processing units, memory units, and storage units that are physically or logically part of the server or an associated local computing system controlled by the same managing entity.

The term “external computational resources” refers to processing units, memory units, and storage units that are provided by a remote computing environment or service accessible via a network and not directly controlled as local hardware by the server.

The term “advertising medium” refers to a form or channel through which advertising content is presented to users, including but not limited to online banner slots, in-application display areas, and web page sections.

The term “printed medium” refers to a physical medium on which content is printed, including but not limited to flyers, brochures, posters, and direct mail items.

The term “electronic distribution medium” refers to a digital channel or format used to distribute content electronically, including but not limited to email messages, mobile application notifications, and network-based advertisements.

In one embodiment, a server implements the claimed system as a network-connected computing apparatus equipped with at least one processor, a main memory, a non-volatile storage device, a network interface, and one or more graphics processing units. The server executes an operating system, such as a general-purpose server operating system, and middleware including a web server framework, a database management system, and an application execution environment for a programming language, such as a Python runtime.

The server communicates with one or more terminals via a communication network, such as the Internet or a wireless communication network.

The server stores program modules that correspond to functional components of the claimed system, including a user information acquisition module, a market information acquisition module, an emotion analysis module, a feature construction module, a prompt generation module, a generative AI invocation module, a post-processing module, a distribution module, and a learning module. Each module is implemented as executable instructions stored in the non-volatile storage device and loaded into the main memory for execution by the processor. The terminal is implemented as an information processing terminal such as a smartphone, a tablet device, or a personal computer. The terminal comprises a processor, a memory, a display unit, an imaging device, an audio acquisition device, and a communication interface. The terminal executes an application that communicates with the server over the network. The application collects user inputs, displays personalized content received from the server, and transmits viewing and manipulation operation information back to the server.

The user operates the terminal to provide explicit user-related information, such as age, gender, interests, and preferred content categories, through graphical user interfaces rendered on the display unit. The user permits the application to access the imaging device and the audio acquisition device, thereby allowing the terminal and the server to collect observation information including captured images, video frames, and audio recordings.

The server uses the user information acquisition module to receive user-related information from the terminal and from one or more storage systems. The server stores basic user profile records in a relational database or a key-value store, where each record includes fields for user identifier, age group, gender, interest categories, purchase history summary, and other attributes. The server converts unstructured inputs, such as free-text interest descriptions, into structured attribute information via text processing routines that perform tokenization, normalization, and mapping to controlled vocabularies.

The server uses the market information acquisition module to retrieve market-related information from external systems and internal analytic databases. The server collects segment definitions, product categories, campaign identifiers, and trend indicators. The server associates the market-related information with user-related information by joining records on common keys such as product identifiers, campaign identifiers, or segment identifiers. This combination provides a richer context for subsequent content generation.

The server uses the emotion analysis module to compute an emotional state of the user from multi-modal observation information. In one embodiment, the server receives raw image frames and audio segments from the terminal via secure communication. The server applies an image analysis pipeline built with an image processing library and a neural network framework. The server performs face detection using a convolutional neural network, extracts facial landmarks representing eyes, nose, and mouth, and normalizes the cropped face images to a fixed resolution and color space. The server feeds the normalized images into an emotion classification neural network, which may be a convolutional neural network with several convolutional and pooling layers followed by fully connected layers. The neural network outputs a probability distribution over predefined emotion classes, such as joy, sadness, anger, fear, and neutral. The server selects the emotion class with the highest probability as the emotional state and retains the probability vector as confidence scores.

In another embodiment, the server performs voice-based emotion analysis. The server computes short-time Fourier transforms of the audio signal to obtain spectrograms and extracts acoustic features such as pitch, energy, and formants. The server inputs the feature vectors into a recurrent or transformer-based neural network trained to classify emotional tone. The server combines the results of image-based and audio-based emotion classification using a fusion strategy, such as weighted averaging of probability vectors or a secondary classifier that operates on concatenated probability vectors. The server thus obtains a unified emotional state and associated confidences.

In yet another embodiment, the terminal performs at least part of the emotion analysis using an on-device neural network model optimized for mobile execution. The terminal detects simple emotional states, such as smile or neutral, and transmits only the resulting label and confidence to the server. This configuration reduces the volume of raw sensor data transmitted over the network, which decreases communication load and improves privacy.

The server uses the feature construction module to integrate attribute information, market-related information, and emotional state into feature information. The server defines a feature vector structure that contains discrete and continuous components, including age group indices, gender indices, interest category embeddings, purchase history counts, market segment identifiers, and emotion class probabilities. The server encodes categorical values as one-hot vectors or learned embeddings and scales numerical values into normalized ranges. The server concatenates these representations into a multi-dimensional feature vector. This structured feature vector can be processed efficiently by the generative AI model and supports high-throughput inference on the server's processor and graphics processing units. The server uses the prompt generation module to convert the feature information into a prompt sentence suitable for a generative AI model. The server maintains a set of prompt templates in a template store. Each template is a natural language pattern that includes placeholders for age group, gender, interests, market segment, emotional state, content type, and expression style. The server selects a template according to conditions derived from the feature information, such as content type, platform of distribution, or market segment. The server then fills each placeholder with textual expressions corresponding to the encoded attributes and emotional state.

The server, for example, generates prompt sentences such as:

“User is a woman in her twenties who is interested in fashion and often buys dresses and accessories. Current emotion is joy. Please generate a bright, trendy fashion advertisement design and a short, catchy message that fits this joyful mood.”

“User is a woman in her thirties, often buying outdoor gear and loving travel. Current emotion is joy. Please generate a vibrant travel promotion banner and an inspiring message.”

“The user's emotion is sadness. The user is a man in his forties interested in health care. Please generate a calm advertisement design with an empathetic message.”

The server constructs these prompt sentences by applying deterministic rules that map the feature vector elements to textual tokens and phrases. For example, the server maps an age group code to a phrase “in her twenties,” a primary interest code to “interested in fashion,” and an emotion class of “joy” to “current emotion is joy.” The server can embed additional instructions for style, such as “bright,” “muted,” “playful,” or “calm,” based on predefined control rules that link emotion categories to style descriptors. This rule-driven construction of the prompt sentence constitutes a specific algorithmic method for transforming structured feature information into natural language, which improves the reproducibility and controllability of generative model behavior compared to manually authored prompts.

The server uses the generative AI invocation module to input the prompt sentence into a generative AI model and obtain content data. In one embodiment, the server executes an internal text generation model implemented as a transformer-based neural network. The server tokenizes the prompt sentence, maps the tokens to embeddings, and feeds the embeddings into multiple transformer layers that perform self-attention and feed-forward operations. The server uses trained model parameters stored in the server's storage to perform matrix multiplications and non-linear activations during inference. The model outputs token probability distributions for each position in the generated text. The server applies a sampling procedure, such as top-k sampling or nucleus sampling, to select tokens and build the generated character string information, such as an advertisement message.

In a similar manner, the server uses an internal image generation model, such as a generative adversarial network or a variational autoencoder, to generate visual elements. The server encodes style and content information derived from the prompt sentence into latent vectors and decodes the latent vectors into images through a sequence of deconvolution and upsampling layers. The server obtains image tensors that correspond to advertisement banners or other visual content. The server encodes the images into compressed formats and stores them as part of the content data.

In another embodiment, the server selects an external generative AI model operating on external computational resources. The server sends the prompt sentence to a remote text generation service or image generation service via a standardized application programming interface. The server receives generated text and image data and integrates them with internal representations. The processor selects between internal and external generative AI resources based on criteria such as latency, cost, or content type. This selection mechanism optimizes computational resource utilization and can reduce response times by routing requests to the most suitable model.

The server uses the post-processing module to adjust content data according to predetermined control rules and the emotional state. The server analyzes the generated character string information to detect sentiment, presence of required keywords, and adherence to style constraints. The server may apply an additional transformer-based model specialized in text refinement, using a secondary prompt sentence such as:

“Original message: ‘[generated text]’. User emotion is joy. Please rewrite this message to be cheerful and positive while remaining appropriate for advertising.”

The server evaluates the refined output against rule-based filters that check for prohibited terms or tone mismatches. By applying structured rules in combination with learned models, the server performs a non-conventional integration of symbolic and sub-symbolic processing, which improves control over the generated content and reduces the likelihood of undesirable outputs.

The server performs visual post-processing using an image processing library. The server adjusts color tone, brightness, and contrast of the generated images based on the emotional state and style rules. For example, when the emotional state is joy, the server increases brightness and saturation according to defined parameter ranges, while for sadness, the server reduces saturation and employs cooler color tones. The server composes layout structures by placing text and images in predefined regions of an advertisement frame according to layout templates. This composition uses explicit coordinates and font styles stored in layout configuration data. Such structured layout processing ensures that content is rendered in a visually consistent and legible manner across different terminals.

The server uses the distribution module to package personalized content and send it to the terminal or to external platforms. The server constructs a content package comprising a reference to image data, the generated character string information, and layout metadata. The server formats this package in a machine-readable format and transmits it through a communication path to the terminal. Alternatively, the server integrates with an electronic mail distribution infrastructure or an information providing platform by constructing content objects in formats required by those systems.

The terminal receives the content package and stores it temporarily in the terminal's memory. The terminal renders the visual elements on the display unit using graphics APIs. The terminal positions images and text according to the layout metadata and applies font sizes and colors specified by the server. The terminal outputs the personalized content while the user interacts with the device. In some embodiments, the terminal preloads content for predicted future usage, thereby reducing perceived latency.

The server uses the learning module to collect reaction information and adjust future processing. The terminal monitors viewing operation information, such as how long the personalized content remains on screen and whether the user scrolls past the content. The terminal also monitors manipulation operation information, such as taps, clicks, or swipes performed on the content area. The terminal transmits these logs to the server periodically or in real time. The server aggregates the reaction information and associates it with the corresponding prompt sentence, feature information, and emotional state. The server stores this association in a training data repository.

The server employs a learning procedure in which it updates at least two aspects of the system: the generation conditions of the prompt sentence and the generation conditions of the content data. For prompt sentence generation, the server adjusts parameters that determine template selection, wording choices, and style descriptors. For example, if reaction information indicates that a specific combination of phrases and style terms leads to higher engagement for users with a certain emotional state, the server increases the probability of selecting that combination in future prompts. The server may model these probabilities using parameterized distributions or small neural networks that map feature information to template and phrase selections.

For content data generation, the server may fine-tune neural network parameters of the generative AI models based on the accumulated reaction information. The server defines an objective function that reflects user engagement or other metrics derived from reaction information. The server computes gradients of this objective with respect to model parameters using backpropagation and updates the parameters with an optimization algorithm, such as stochastic gradient descent or adaptive optimization. The server can also adjust decoding parameters for text generation, such as temperature or sampling thresholds, based on observed performance by emotional state and user segment. This adaptive mechanism enhances the ability of the server to converge on configurations that deliver higher relevance and effectiveness.

From a computer-technology perspective, the described system provides technical improvements beyond mere automation of human tasks. The integration of multi-modal emotion analysis, structured feature construction, and deterministic prompt sentence generation enables the server to produce highly structured and context-rich inputs for generative AI models. This structured approach reduces trial-and-error in prompt authoring, improves stability of generated outputs, and allows the server to execute high-volume, low-latency content generation on shared hardware resources. The server's use of fused features and rule-based control, combined with adaptive learning from reaction information, improves the computational efficiency and accuracy of personalized content selection compared to conventional rule-only or model-only systems.

Furthermore, the server reduces network load by optionally delegating coarse emotion analysis to the terminal and transmitting compact emotion labels instead of raw image and audio data. The system also optimizes usage of computational resources by dynamically selecting between internal and external generative models depending on operational conditions. These architectural decisions lead to measurable performance gains in terms of reduced latency, lower bandwidth consumption, and improved throughput, and are achieved through specific data structures, processing flows, and algorithms as described above. Alternative embodiments are possible within the scope of the claims. In one variation, the server employs different neural network architectures, such as recurrent networks or hybrid convolutional-transformer models, to perform emotion analysis or content generation. In another variation, the server stores feature information in a graph database and utilizes graph-based encodings when constructing prompt sentences. In yet another variation, the server implements additional control rules that enforce consistency of brand identity or regulatory compliance while still utilizing emotional state and user attributes. In all these embodiments, the server, the terminal, and the user interact in the manner described, and the processor performs the specific technical operations of feature construction, prompt sentence generation, generative AI invocation, post-processing, distribution, and learning, thereby enabling practical implementation of the claimed system.

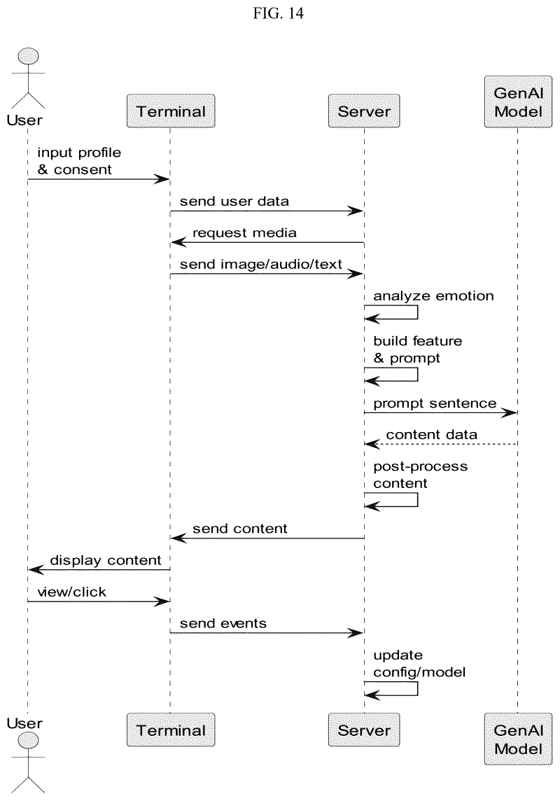

The following describes the processing flow using FIG. 14.

### Step 1:

Server acquires user-related information and market-related information.

Server receives, as input, explicit user-related information from terminal (for example, age, gender, interest selections, and consent flags) and implicit user-related information from storage (for example, purchase history records and browsing logs), together with market-related information from databases or external services (for example, product categories and campaign identifiers). Server performs data processing by parsing incoming JSON or form-encoded payloads, normalizing text fields (lowercasing, trimming), converting enumerated values into internal codes, and joining user records with market records based on user identifiers and product identifiers. Server outputs normalized user profile data and associated market context data, stored in structured records in a database and cached in main memory for subsequent steps.

### Step 2:

Server performs multi-modal emotion analysis to determine an emotional state of the user.

Server receives, as input, observation information from terminal, which includes image frames from the imaging device, audio segments from the audio acquisition device, and optional text messages from the character information acquisition device. Server performs data processing by resizing and normalizing image frames, applying face detection to obtain cropped face regions, and extracting facial landmarks; by computing audio features such as short-time Fourier transforms, mel-frequency cepstral coefficients, and energy curves; and by tokenizing and embedding text strings. Server inputs these processed features into one or more trained neural network models (for example, a convolutional neural network for facial emotion, a recurrent or transformer model for vocal emotion, and a text sentiment classifier), and performs numerical computations (matrix multiplications, nonlinear activations, softmax operations) to obtain probability distributions over emotion classes. Server fuses these distributions (for example, via weighted averaging or a secondary classifier) to output a unified emotional state label and corresponding confidence scores, which are stored in association with the user profile.

### Step 3:

Server constructs feature information by integrating attribute information, market-related information, and emotional state.

Server receives, as input, normalized user profile data from Step 1 (including age group, gender, interests, and purchase history), market context data (segment identifiers, campaign types), and emotional state information from Step 2. Server performs data processing by encoding categorical attributes as one-hot vectors or embedding indices, scaling numerical attributes (such as purchase counts) with normalization functions, and concatenating all encoded features into a multi-dimensional feature vector. Server may compute additional derived features, such as recency scores for purchases or intensity measures derived from emotion confidence values, using arithmetic operations and weighting coefficients. Server outputs structured feature information that includes both the feature vector and symbolic tags (for example, “age group: 20s”, “emotion: joy”, “primary_interest: fashion”).

### Step 4:

Server generates a prompt sentence for a generative AI model based on the feature information.

Server receives, as input, the feature information from Step 3. Server performs data processing by selecting a prompt template from a template store according to feature attributes such as content type, platform type, and primary interest. Server maps feature values to textual phrases using rule tables (for example, mapping an age group code to “in her twenties” and an interest code to “interested in fashion”) and inserts these phrases into placeholder positions in the selected template. Server may apply grammatical adjustments (such as pluralization and pronoun selection) using simple syntactic rules. Server outputs a prompt sentence in natural language that encodes user attributes, market context, and emotional state. For example, server outputs: “User is a woman in her twenties who is interested in fashion and often buys dresses and accessories. Current emotion is joy. Please generate a bright, trendy fashion advertisement design and a short, catchy message that fits this joyful mood.”

### Step 5:

Server invokes a generative AI model with the prompt sentence to generate content data.

Server receives, as input, the prompt sentence from Step 4. For an internal generative AI model, server performs data processing by tokenizing the prompt sentence into subword units, mapping tokens to embeddings, and executing a transformer-based neural network with multiple attention layers and feed-forward layers on a processor and optionally on a graphics processing unit. Server computes hidden representations and output probability distributions over vocabulary tokens for each generation step, then applies a decoding strategy (for example, top-k sampling or nucleus sampling) to iteratively select tokens and form generated character string information such as an advertisement message. For an image generation model, server encodes style and content constraints from the prompt into a latent vector, then applies a generative neural network (for example, a deconvolutional network) to compute image tensors representing visual elements. For external generative AI models, server transmits the prompt sentence to remote services through an application programming interface and receives generated text and image data. Server outputs content data that includes visual elements (for example, images or design specifications) and character string information (for example, headline and body text).

### Step 6:

Server performs post-processing on the generated content data based on emotional state and control rules.

Server receives, as input, the content data from Step 5 and the emotional state information from Step 2. Server performs data processing by parsing the generated character string information to detect sentiment, prohibited terms, and length, using natural language analysis routines, and by adjusting color tone and layout attributes of visual elements using image processing functions and layout rules. If the emotional state is “joy,” server increases brightness and saturation parameters, selects positive adjectives, and, if needed, sends a refinement prompt sentence such as “Original message: ‘[generated text]’. User emotion is joy. Please rewrite this message to be cheerful and positive while remaining appropriate for advertising.” to a text-refinement generative AI model. If the emotional state is “sadness,” server applies calmer color palettes and empathetic wording adjustments. Server outputs personalized content that satisfies predefined style constraints and is aligned with the emotional state, including finalized images, text strings, and layout metadata.

### Step 7:

Server packages the personalized content and distributes it to terminal or external platforms.

Server receives, as input, the personalized content from Step 6 and distribution parameters (for example, target terminal identifiers or platform identifiers). Server performs data processing by constructing a content package containing references or binary data for images, text fields for headlines, body texts, and call-to-action messages, and layout configuration data (for example, coordinates and font specifications). Server encodes this package in a machine-readable format and stores images in a storage subsystem if necessary. Server then transmits the content package via a communication path to terminal through a web service endpoint or forwards appropriately formatted content to electronic mail distribution infrastructure or an information providing platform. Server outputs delivered content packages that can be rendered on user-facing interfaces.

### Step 8:

Terminal displays the personalized content and collects viewing and manipulation operation information.

Terminal receives, as input, a content package from server in Step 7. Terminal performs data processing by parsing the package, downloading referenced images if required, and rendering visual elements on the display unit using graphics APIs. Terminal positions images and text according to layout configuration, applies color and font settings, and draws interactive components such as buttons. While user interacts with the displayed content, terminal records viewing operation information (for example, display duration and scroll position) and manipulation operation information (for example, taps and clicks) by listening to user interface events and timestamping them. Terminal outputs event logs that describe how personalized content was viewed and manipulated, and transmits these logs back to server over the communication interface.

### Step 9:

Server learns from reaction information to update generation conditions for future prompt sentences and content data.

Server receives, as input, event logs from terminal in Step 8, along with the identifiers of the corresponding prompt sentence, feature information, and emotional state used when generating the displayed content. Server performs data processing by aggregating events, computing engagement metrics such as click-through rates and view durations for combinations of attribute information and emotional states, and associating these metrics with the prompt templates and generative model parameters used. Server then updates generation conditions of the prompt sentence by adjusting template selection probabilities and phrase usage weights, and may update generation conditions of the content data by tuning decoding parameters or fine-tuning neural network weights using gradient-based optimization on mini-batches of logged interactions. Server outputs updated configuration data and, if applicable, updated model parameters that will be used in future executions of Steps 4 through 6 to improve relevance, accuracy, and efficiency of personalized content generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

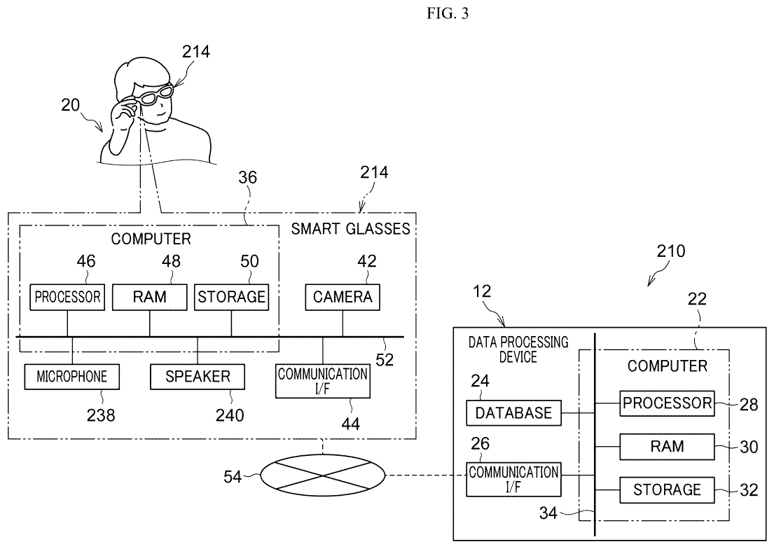

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

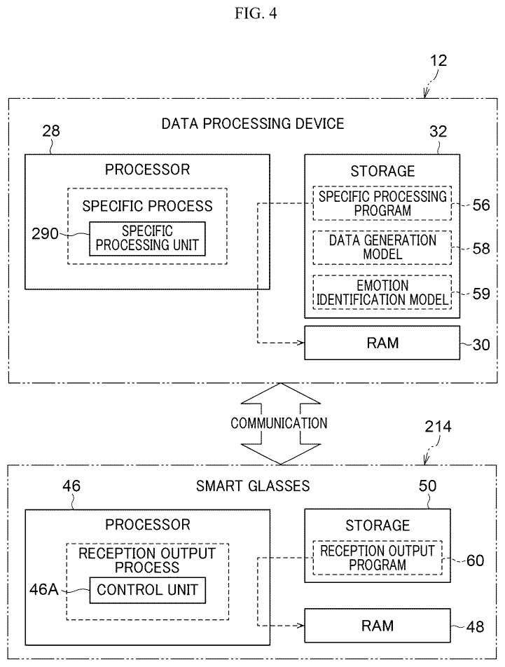

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

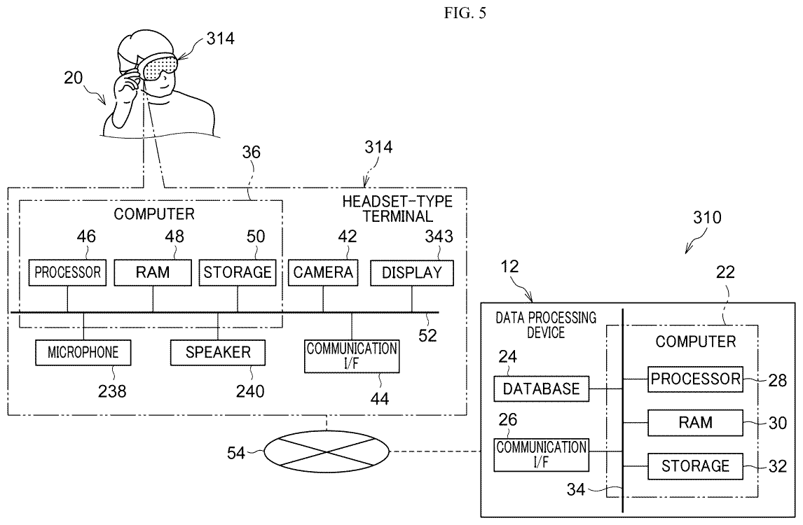

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

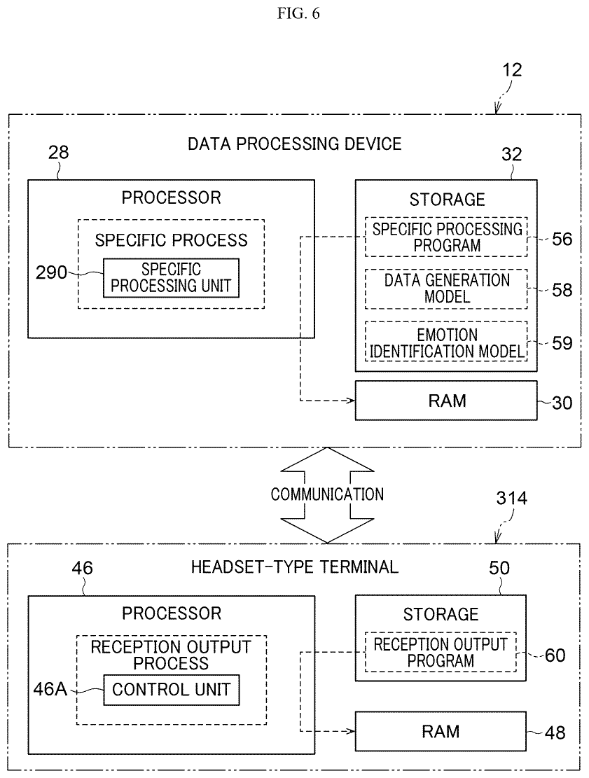

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

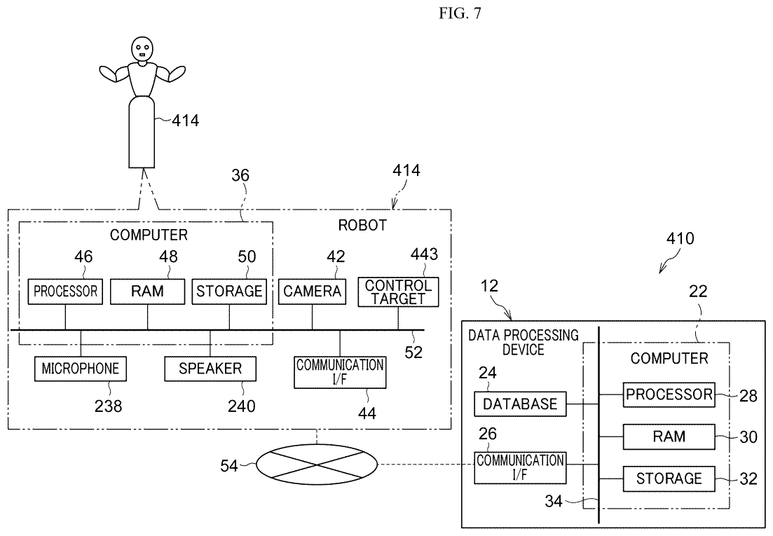

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

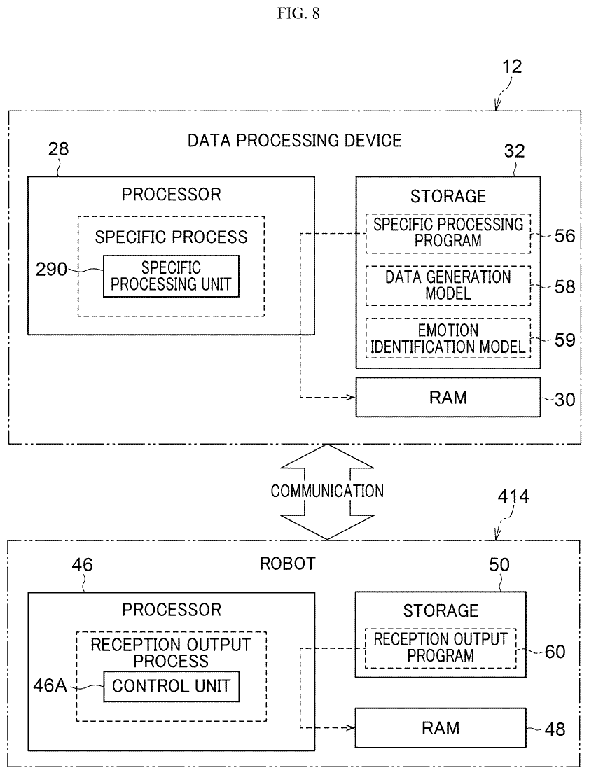

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

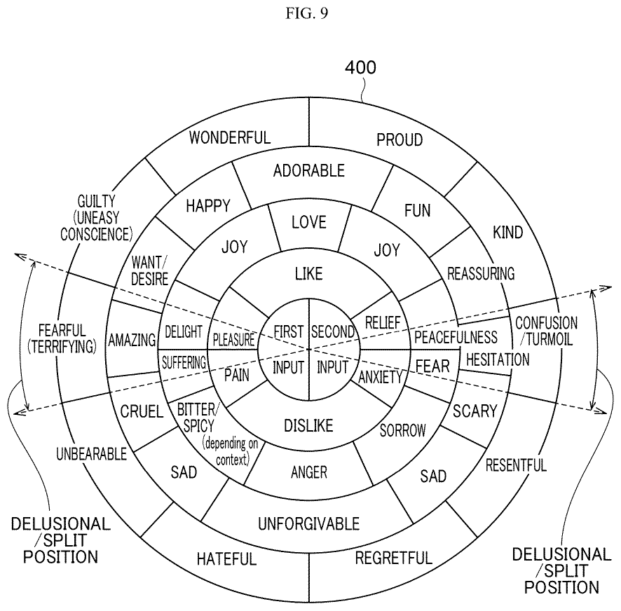

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

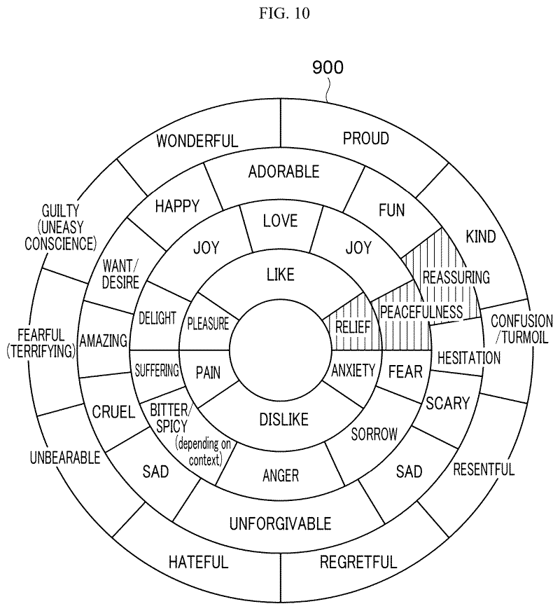

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, wherein the processor is configured to
receive market information and attribute information of a target population,
acquire related information from an information storage device and an external information providing device based on the market information and the attribute information,
perform preprocessing on the related information and the attribute information by using an information processing program, the preprocessing including normalization processing, encoding processing, and feature extraction processing, and generate generation feature data, generate, based on the generation feature data and a high-level instruction sentence input by a user, a generative AI model prompt sentence for a generative AI model by expanding the high-level instruction sentence to include statistical information of the target population, preference information, and output format information,
execute a content generation program by using the generative AI model prompt sentence and the generation feature data as input, and generate generated content including character information and visual information,
perform postprocessing on the generated content, the postprocessing including format conversion processing, component organization processing, and individual identification information assignment processing, and generate delivery content resources and management information associated with the delivery content resources,
present the delivery content resources and the management information to a terminal device including a display device, accept candidate selection operations by the user, and identify selected delivery content resources,
assign, based on the selected delivery content resources and attribute information of individual recipients belonging to the target population, the delivery content resources to each recipient and generate individualized delivery messages, and
transmit the individualized delivery messages via a communication network to an information delivery service device so that the individualized delivery messages are delivered to end users through an electronic communication service or a social network advertising service.

### (Supplementary 2)

The system according to supplementary 1, wherein the processor is configured to
store the related information and the attribute information in a tabular data structure, perform data shaping processing including missing value processing, scale transformation of numerical features, and numerical representation conversion of categorical features to generate the generation feature data, and automatically generate the generative AI model prompt sentence by combining the high-level instruction sentence with statistical values calculated from the tabular data structure.

### (Supplementary 3)

The system according to supplementary 1, wherein the processor is configured to
execute an assignment process for the delivery content resources by applying, according to the attribute information of each recipient belonging to the target population, an assignment rule that selects one of a plurality of types of the delivery content resources, or by executing a statistical evaluation process or a machine learning process that determines, based on performance indicators of the plurality of types of the delivery content resources, which delivery content resource is to be assigned to each recipient, and thereby generate the individualized delivery messages.

### Application Example 1

### (Supplementary 1)

A system comprising a processor, wherein the processor is configured to
acquire market information and target user information, obtain attribute information of a user based on the target user information, and perform emotion analysis to recognize an emotional state of the user based on the market information and the target user information,
dynamically construct a prompt sentence for causing a generative artificial intelligence model to generate character information and visual information, based on the market information, the target user information, the attribute information, and a result of the emotion analysis, encode the prompt sentence into an input format acceptable to the generative artificial intelligence model, and input the encoded prompt sentence to the generative artificial intelligence model,
construct advertisement information data based on the character information and the visual information output from the generative artificial intelligence model, and convert the advertisement information data into notification data for transmission to a portable information terminal via a messaging infrastructure,
distribute, in response to a request from the portable information terminal and based on identification information included in the notification data, the advertisement information data so that the character information and the visual information are presented as personalized display content on the portable information terminal, and
acquire viewing information or operation information relating to the display content from the portable information terminal, and update at least one of the prompt sentence and generation conditions of the generative artificial intelligence model based on the viewing information or the operation information.

### (Supplementary 2)

The system according to supplementary 1, wherein the processor is configured to
analyze the visual information output from the generative artificial intelligence model as structured data including a color attribute, a layout attribute, and an image concept attribute,
generate image-generation text information for input to an image generation model based on the structured data, and store image data generated by the image generation model in association with the advertisement information data.

### (Supplementary 3)

The system according to supplementary 1, wherein the processor is configured to
convert the advertisement information data into at least one of electronic notification data, print data, and external output data according to a distribution medium, use the electronic notification data for push-type distribution to the portable information terminal, and edit the print data and the external output data into a format outputtable as an advertising medium, a distribution medium, or a display medium.

### Example 2

### (Supplementary 1)

A system comprising a processor,
wherein the processor is configured to receive, from an information processing terminal, attribute information and behavioral information relating to a market and target users,
store the attribute information and the behavioral information in a storage device, and perform preprocessing including missing-value processing, noise removal, normalization, and encoding on the attribute information and the behavioral information so as to convert the attribute information and the behavioral information into feature quantities for machine learning,
automatically construct a prompt sentence based on the preprocessed information, the prompt sentence including conditions indicating an age group, a gender, preferences, interests, purchasing tendencies, and needs of a target population, and including a delivery medium, an expression style, and brand constraints,
provide the prompt sentence and the feature quantities as inputs to a generative AI model and cause the generative AI model to generate design data and text data corresponding to the target population,
automatically allocate the generated design data and the generated text data to at least one of an electronic mail template, a network distribution advertisement template, and a printed matter template, and convert the generated design data and the generated text data into advertisement content data,
transmit the advertisement content data, via an electric communication network, to an electronic mail distribution apparatus or a social network advertisement distribution apparatus so as to cause personalized content to be delivered to end users, and
record, in association with each target population, the prompt sentence, the inputs to the generative AI model, and outputs from the generative AI model, and accumulate the recorded information as history information reusable in subsequent content generation processing.

### (Supplementary 2)

The system according to supplementary 1, wherein the processor is configured to
perform image analysis processing on image information acquired from an image acquisition apparatus or a video acquisition apparatus, extract feature quantities indicating at least one of human attributes, scene attributes, and product attributes from the image information, and use the extracted feature quantities as conditions for causing the generative AI model to generate the design data and the text data by including the extracted feature quantities in the prompt sentence.

### (Supplementary 3)

The system according to supplementary 1, wherein the processor is configured to
automatically edit the text data and the design data, in order to adapt the advertisement content data to constraint conditions for individual distribution channels, based on at least one of a character-number limitation, a pixel-number limitation, an image layout limitation, and a prohibited-expression condition, and transmit the edited advertisement content data to the electronic mail distribution apparatus or the social network advertisement distribution apparatus so as to perform an approach to the end users.

### Application Example 2

### (Supplementary 1)

A system comprising a processor, wherein the processor is configured to
acquire user-related information and market-related information, extract attribute information from the user-related information, and perform emotion analysis that identifies an emotional state of a user based on observation information obtained from an imaging device, an audio acquisition device, and a character information acquisition device,
generate feature information including a plurality of elements comprising at least an age group, a gender, an interest, a purchase history, the emotional state, a content type, and an expression style, on the basis of the attribute information and the emotional state, and convert the feature information into a natural language expression to construct a prompt sentence serving as input to a generative artificial intelligence model,
input the prompt sentence into the generative artificial intelligence model and cause the generative artificial intelligence model to generate content data including visual elements and character string information corresponding to the feature information and the emotional state, perform post-processing based on the emotional state and predetermined control rules to correct at least one of a color tone, a layout, a wording tone, and a message content in the content data, and thereby construct personalized content for an end user,
distribute the personalized content to an information processing terminal via a communication path, or distribute the personalized content via an electronic mail distribution infrastructure or an information providing platform, and
collect reaction information to the personalized content based on viewing operation information and manipulation operation information acquired from the information processing terminal, record the reaction information in association with the prompt sentence and the emotional state, and execute a learning process that updates at least one of generation conditions of the prompt sentence and generation conditions of the content data for a subsequent generation process.

### (Supplementary 2)

The system according to supplementary 1, wherein the processor is configured to
generate the prompt sentence by selecting first template information based on the feature information, and embedding the attribute information, the emotional state, and style information according to the reaction information into the template information, thereby constructing a plurality of prompt sentences that simultaneously instruct the generative artificial intelligence model to generate the visual elements and the character string information.

### (Supplementary 3)

The system according to supplementary 1, wherein the processor is configured to
select at least one of a first generative artificial intelligence model operating on internal computational resources and a second generative artificial intelligence model operating on external computational resources, transmit the prompt sentence to the selected generative artificial intelligence model to obtain the content data, and convert the obtained content data into a format definition of at least one of an advertising medium, a printed medium, and an electronic distribution medium to construct the personalized content.

What is claimed is:

1. A system comprising:
circuitry configured to:
receive, via a communication interface coupled to a packet-switched network, attribute data and related information from an information storage device and an external information providing device, and preprocess the attribute data and the related information using an information processing program, the preprocessing comprising normalization processing, encoding processing, feature extraction processing, missing value processing, scale transformation of numerical features, and numerical representation conversion of categorical features;
store the preprocessed information in a tabular data structure and generate generation feature data from the tabular data structure;
generate a generative AI model prompt sentence based on the generation feature data and a high-level instruction sentence by expanding the high-level instruction sentence to include statistical information of a target group, preference information, and output format information calculated from the tabular data structure;
execute a content generation program by inputting the generative AI model prompt sentence and the generation feature data to a generative AI model to generate generated content comprising character information and visual information; and
perform postprocessing on the generated content, the postprocessing comprising format conversion processing, component organization processing, and individual identification information assignment processing, and generate processed output data from the postprocessed content.

2. The system according to claim 1, wherein the circuitry is configured to
generate management information associated with the processed output data, present the processed output data and the management information to a terminal device via the communication interface, accept candidate selection operations received from the terminal device, and identify selected processed output data.

3. The system according to claim 2, wherein the circuitry is configured to
assign, based on the selected processed output data and individual attribute information of recipients belonging to the target group, the processed output data to each recipient and generate individualized delivery messages.

4. The system according to claim 3, wherein the circuitry is configured to
execute an assignment process by applying an assignment rule that selects one of a plurality of types of the processed output data according to the individual attribute information, or by executing a machine learning process that determines, based on performance indicators of the plurality of types of the processed output data, which processed output data is to be assigned to each recipient.

5. The system according to claim 4, wherein the circuitry is configured to
transmit the individualized delivery messages via the communication interface to an information delivery service device so that the individualized delivery messages are delivered to end users.

6. The system according to claim 1, wherein the circuitry is configured to
apply emotion recognition processing to sensor data received from a terminal device to generate an emotion label, and incorporate the emotion label into the generative AI model prompt sentence.

7. The system according to claim 6, wherein the circuitry is configured to
acquire image feature data by applying an image analysis model to at least one of photograph data or video data received via the communication interface, and include the image feature data in the generative AI model prompt sentence in addition to the generation feature data and the emotion label.

8. The system according to claim 7, wherein the image analysis model comprises a convolutional neural network trained to extract visual features from the photograph data or the video data.

9. The system according to claim 6, wherein the circuitry is configured to
dynamically adjust the generative AI model prompt sentence based on the emotion label by modifying at least one of a tone instruction, a visual style instruction, or an output length parameter in the prompt sentence.

10. The system according to claim 1, wherein the circuitry is configured to
apply missing value processing to the attribute data by imputing missing values using a statistical imputation method, and apply scale transformation to normalize numerical features to a common range prior to generating the generation feature data.

11. The system according to claim 1, wherein the tabular data structure stores the preprocessed information as rows corresponding to individual recipients and columns corresponding to attribute dimensions.

12. The system according to claim 1, wherein the circuitry is configured to
convert the generated content into at least two output format types comprising display format data and document format data, and store the converted output format types as the processed output data.

13. The system according to claim 1, wherein the circuitry is configured to
generate a plurality of candidate generative AI model prompt sentences by applying different combinations of statistical information and preference information extracted from the tabular data structure, and select one candidate prompt sentence based on a predicted content quality score.

14. The system according to claim 13, wherein the predicted content quality score is computed by a scoring model trained on performance indicators of previously generated processed output data.

15. The system according to claim 1, wherein the circuitry is configured to
record execution logs comprising the generative AI model prompt sentence and the corresponding generated content for each invocation of the generative AI model, and store the execution logs in a memory for audit and reproducibility.

16. The system according to claim 15, wherein the circuitry is configured to
analyze the execution logs to compute aggregate performance statistics for the processed output data, and update the high-level instruction sentence expansion logic based on the aggregate performance statistics.

17. The system according to claim 1, wherein the generation feature data is generated by applying dimensionality reduction or feature selection to the tabular data structure to identify a subset of attribute dimensions having highest predictive relevance for the target group.

18. A system comprising:
circuitry configured to:
preprocess attribute data and related information to generate a tabular data structure, and generate generation feature data by applying normalization processing, encoding processing, and feature extraction processing to data stored in the tabular data structure;
generate a generative AI model prompt sentence by expanding a high-level instruction sentence to include statistical information and preference information derived from the generation feature data;
input the generative AI model prompt sentence to a generative AI model to generate generated content comprising character information and visual information; and
perform format conversion processing and component organization processing on the generated content to generate processed output data, and assign the processed output data to individual recipients based on individual attribute information using a machine learning process.

19. The system according to claim 18, wherein the circuitry is configured to
apply emotion recognition processing to sensor data from a terminal device to generate an emotion label, and dynamically adjust at least one instruction parameter in the generative AI model prompt sentence based on the emotion label.

20. A method comprising:
receiving, via a communication interface coupled to a packet-switched network, attribute data and related information from an information storage device and an external information providing device, and preprocessing the attribute data and the related information using an information processing program, the preprocessing comprising normalization processing, encoding processing, feature extraction processing, missing value processing, scale transformation of numerical features, and numerical representation conversion of categorical features;
storing the preprocessed information in a tabular data structure and generating generation feature data from the tabular data structure;
generating a generative AI model prompt sentence based on the generation feature data and a high-level instruction sentence by expanding the high-level instruction sentence to include statistical information of a target group, preference information, and output format information calculated from the tabular data structure;
executing a content generation program by inputting the generative AI model prompt sentence and the generation feature data to a generative AI model to generate generated content comprising character information and visual information; and
performing postprocessing on the generated content, the postprocessing comprising format conversion processing, component organization processing, and individual identification information assignment processing, and generating processed output data from the postprocessed content.
